(19) United States
(12) Patent Application Publication
(10) Pub. No.: US 2004/0064692 A1
(43) Pub. Date: Apr. 1, 2004

(54) Identifying, managing, accessing, and tracking digital objects and associated rights and payments

(75) Inventors: Robert E. Kahn, McLean, VA (US); David K. Ely, Oakton, VA (US)

Correspondence Address: FISH & RICHARDSON PC, 225 FRANKLIN ST, BOSTON, MA, 02110, US

(73) Assignee: Corporation for National Research Initiatives, a Virginia corporation

(21) Appl. No.: 10/678,356

(22) Filed: Oct. 2, 2003

Related U.S. Application Data
(63) Continuation of application No. 10/351,571, filed on Jan. 24, 2003.
Application No. 10/351,571 is a continuation of application No. 10/035,021, filed on Dec. 26, 2001, now abandoned.
Application No. 10/035,021 is a continuation of application No. 08/645,491, filed on May 13, 1996, now abandoned.
Application No. 08/645,491 is a continuation-in-part of application No. 08/142,161, filed on Oct. 22, 1993, now abandoned.

(51) Int. Cl. H04L 9/00

(52) U.S. Cl. 713/167; 705/51

(57) ABSTRACT

A method of managing digital objects in a network is presented. The objects are stored at locations accessible in the network using a storage technique which renders the digital objects secure against unauthorized access. Pointer information which associates each digital object identifier with a pointer indicating the location of the stored digital object is also stored in the network. For each digital object validation information is stored, separately from the digital object, and is sufficient to permit a determination whether a purported instance of a digital object is identical to the original. Other aspects include storing validation information which is substantially smaller in size than the corresponding digital object; storing validation information separately from the digital object; providing multiple servers each of which accepts identifiers of a subset of the digital objects and returns corresponding pointers to the locations of the digital objects in the network; registering rights in digital objects by submitting an application including the validation information and the unique identifier of a digital object; enabling holders of rights in digital objects to control terms and conditions under which they are accessed by users in a network; enabling holders of rights in digital objects to control terms and conditions under which rights in the digital objects may be granted to others; maintaining a record of information concerning digital objects stored on a network; providing a repository service; tracking events in the system; cataloging digital objects, and handling payment for access to digital objects and for obtaining rights using a network-based payment mechanism or compensation.

This is a continuation-in-part of U.S. patent application Ser. No. 08/142,161, filed Oct. 22, 1993.

### BACKGROUND

This invention relates to digital objects and associated rights and payments.

By a “digital object” we broadly mean any set of sequences of bits or digits and an associated unique identifier which we call a “handle”. A digital object may incorporate information or material in which rights (e.g., copyright rights) or other interests are or may be claimed. There may also be rights associated with the digital object itself. Thus digital objects may include conventional digital representations of works (books, papers, images, sounds, software), and more broadly any digital material which is capable of producing desired manifestations for a computer user. Thus, a digital object could include programs and data which, though not directly a representation of the text of a work, enable the delivery over a network and the subsequent reproduction on a computer screen of selected portions of the text of the work. By the notion of rights which are or may be claimed in a digital object, we mean rights which exist under statute (e.g., copyright, patent, trade secret, trademark), or as a result of private action (e.g., via secrecy, cooperative ventures, or negotiation).

Rights are normally protected under the law by mechanisms that are paper-based. Patent and trademark applications are prosecuted by exchanges of paper with the Patent and Trademark Office. Trade secret rights-are often protected by appropriate legends on paper, and by physically guarding paper copies against disclosure. Registration of claims in copyright is largely based on a paper system. Registration systems generally involve providing physical copies (sometimes voluminous) to the registering authority of the object to be registered.

Holders of rights may get value from those rights by allowing others to copy, use, or perform the object covered by the rights in exchange for consideration (e.g., a photographer may sell copies of his photographs). In some situations there may no need for negotiation of the terms, which may be simple and well understood. The working out of compensation may be done automatically by private clearing house operations, such as the Copyright Clearance Center (as to photocopying) or ASCAP and BMI (in the music field).

In other situations the rights holders may derive value by granting to others exclusive rights to disseminate the object in exchange for a royalty (e.g., a book author grants a publisher the North American paperback distribution rights). Exclusive rights are typically subject to direct negotiation.

It is common to provide for central registration of ownership and other exclusive rights so that others may know the timing and terms of those rights.

Making digital objects available on networks (e.g., Internet), gives rise to at least four specific activities of concern. The first is the ease of movement of digital objects already contained in a computer network environment allowing the creation of multiple copies in multiple machines in fractions of a second. The second is the importation of external information, such as print material or isolated CD-ROM based material, which must first be scanned or read into the system before it can-be used. The third is export of internal network based information to paper using digital printers or facsimile machines or copying to separable media such as tape or DAT for external transport to others. The fourth is that digital objects may be easily manipulated on a computer to produce derivative works. The derivative works can also be easily moved about in a computer network environment and be subject to further manipulation by other parties. Parallel and concurrent manipulation can generate an exponential proliferation of derivative works.

Several technologies are known for handling privacy and authentication in a digital network environment, including public key cryptography, digital signatures, privacy enhanced mail, and notarization.

### SUMMARY OF THE INVENTION

In general, in one aspect, the invention features a method of managing digital objects in a network, the objects are stored at locations accessible in the network using a storage technique which renders the digital objects secure against unauthorized access. Pointer information which associates each digital object identifier with a pointer indicating the location of the stored digital object is also stored in the network. For each digital object validation information is stored, separately from the digital object, and is sufficient to permit a determination whether a purported instance of a digital object is identical to the original. In examples of the invention, an authorized user may have access to the validation information, using the digital object identifier, to determine whether a purported instance of a digital object is identical to the original. The validation information comprises a digital signature over the digital object.

Another general aspect of the invention concerns managing reference information about digital objects in a network. The reference information is stored for each of the digital objects. Validation information is also stored and is substantially smaller in size than the corresponding digital object. In examples of the invention, an authorized user may have access to the reference information using the unique identifier. The reference information includes information concerning at least one of the following: registration of rights in the digital object including performance of the object; accesses to and uses of digital object; the terms and conditions for use of digital objects; the ownership and transfer of rights to disseminate digital objects; links between different digital objects.

In another general aspect of the invention, which concerns the storing of the digital objects in a network, the verification information is stored separately from the digital object. In examples of this aspect of the invention, the pointer to the object (versus identifier information for the object) is stored in multiple servers on the network. The identifiers are generated in a manner to distribute the pointer information with the unique identifier information) relatively evenly among the servers, using a hashing algorithm.

Another general aspect of the invention concerns enabling users of a network to access or perform digital objects stored in the network. There are multiple pointer servers each of which accepts identifiers of a subset of the digital objects and returns corresponding pointers to the locations of the digital objects in the network. A directory server accepts identifiers of any of the digital objects and maintains and returns a table containing the locations of the pointer servers which accept those identifiers.

Another general aspect of the invention concerns applying for registration of rights in digital objects by submitting to a registering authority an application for registration of rights including the validation information and the unique identifier of a digital object and its properties.

Another general aspect of the invention concerns enabling holders of rights in digital objects to control terms and conditions under which they are accessed or performed by users in a network. Information is stored about terms and conditions for access to and performance of each digital object. The information is made available to a user in connection with a request for access to a digital object. The user is enabled to indicate assent to the terms and conditions. Access is permitted to the user only upon the user indicating assent to the terms and conditions.

Another general aspect of the invention concerns enabling holders of rights in digital objects to control terms and conditions under which rights in the digital objects may be granted to others. Terms and conditions for the granting of rights is stored in the network. The terms and conditions are made available to potential rights holders upon request via the network. The potential rights holder and the current rights holder interact via the network to reach agreement on terms and conditions for grant of dissemination rights. Information identifying grants of such rights for digital objects on the network are stored in a recordation server on the network. This will generally be part of the reference service.

Another general aspect of the invention concerns maintaining a record of information concerning digital objects stored on a network. The digital objects are stored on the network in a manner that restricts unauthorized access to and transactions associated with the digital objects. A reference service is provided on the network, separate from the storage of the digital objects, for recording information about accesses to and transactions associated with the digital objects. Information about accesses to and transactions associated with the digital objects is recorded in the reference service. Access to the records of the reference service is permitted to authorized users.

Another general aspect of the invention relates to managing registration of claims to rights in digital objects. Copies of the digital objects are stored in a repository in a manner that enables only authorized accesses to the digital objects and permits verification that the stored digital objects have not been subjected to unauthorized alteration. At a registrar which is accessible on the network at a different network address from the repository, registration services are provided including receipt via the network of registration requests and delivery via the network of registration certifications. The objects are accessed at the repository via the network for use in providing the registration services.

Examples of the invention include the following features. Owners of rights in digital objects may deposit copies of the digital objects in the repository, via the network. There may be multiple repositories. A set of servers, accessible on the network, are provided for the purpose of generating a unique handle for each digital object. The handle for a digital object is unique both across the network and over time. A service, accessible on the network, is provided for locating the handle associated with a digital object. The handle is used to-obtain a pointer to the network location of an accessible copy (by “copy” we intend a broader concept then the conventional notion of copy; see other sections of this application for explanation) of the digital object. The handle is used to obtain a pointer to the network location of information concerning obtaining authorization to use the digital object. The services are provided at multiple different locations on the network. The handles comprise unique character strings associated with the servers which generated them. A handle server, accessible on the network, provides the pointer in response to presentation of a handle. Multiple servers provide the service, each serving a portion of the handle space. Multiple handle generation servers may generate handles independently. Information concerning simple terms and conditions is stored in the repository. Information concerning non-simple terms is held in a rights management system (it may also contain the simple terms and conditions). Each of the handles is used to obtain a pointer to a rights management system in which information concerning non-simple terms is held. Hash values are computed on the handles and the hash values are distributed among multiple handle servers, each handle server having a table which associates handles with pointers.

Another general aspect of the invention features a method for providing network based regulation of claims in rights in digital objects, and, in connection with actions (e.g., registration of rights or obtaining copies for consideration) pertaining to regulation of claims in rights in the digital objects, using handles to obtain authorized access to the digital objects in the repository. actions include registration of claims in the rights.

Another general aspect of the invention features a network-based method for managing compensation for access to digital objects and transfer of rights in digital objects. Information is stored on the network identifying the ownership of rights in digital objects. At a rights management system available on the network, requests for rights in digital objects are received. In response to the requests for rights (e.g., exclusive rights), and after successful negotiation of rights transfers, requests are issued from the rights management system to the recordation system via the network, to record transfers of rights in the digital objects.

Examples of the invention include the following features. The transfer of rights is recorded in the recordation system in a manner which is secure against alteration. The request for transfer of rights typically occurs after the owner is compensated using a network based method of compensation or other method, or a commitment has been obtained to compensate the owner of the rights using the network-based compensation method or other method.

Among the advantages of the invention are the following.

Any kind of digital object may be dealt with. Owners of digital objects may deposit them in a secure manner that both restricts access and allows for later verification that the deposit has not been altered. Detailed records of the history of deposits and of transactions related to the objects (e.g., transfers of rights) may be kept in a protected location in the system, while access to those records may be allowed to any authorized party on the network. The records may include information about the history of revisions and derivative versions of objects, and may link objects based on other relationships among them.

Thus, in combination the information and reference server (e.g., the registrar) and the repositories provide a unique capability, applicable to any digital object, to provide for protected storage in electronic storage facilities and, in a separate facility, secure maintenance of validation information needed to assure the unaltered nature of the stored object and historical information about the object. In this way, it is not necessary to store the objects at the same location as the validation information and any authorized person on the network (e.g., a court, or a government employee, or the rights holder, or a user) may have access to the validation and historical information and, if authorized, the object itself. When applied broadly to a large number and variety of rights holders and users, the system will produce a digital object infrastructure of enormous value to the conduct of business.

The digital signature, privacy enhanced messaging, and other protection mechanisms assure the integrity of the system.

The present manual paper system for mediating rights in the use of and dissemination of digital objects is replaced by a network-based system that operates rapidly, accurately, and efficiently, and will produce a freer, higher velocity market in such rights, thus greatly enhancing the value of the rights.

Corporations and private institutions may apply the invention in a variety of contexts.

The handles used to uniquely identify digital objects are designed to be extensible and expandable to accommodate virtually any number of objects over many years. The hashing mechanism provides an efficient and reliable implementation.

Other advantages and features will become apparent from the following description and from the claims.

### DESCRIPTION

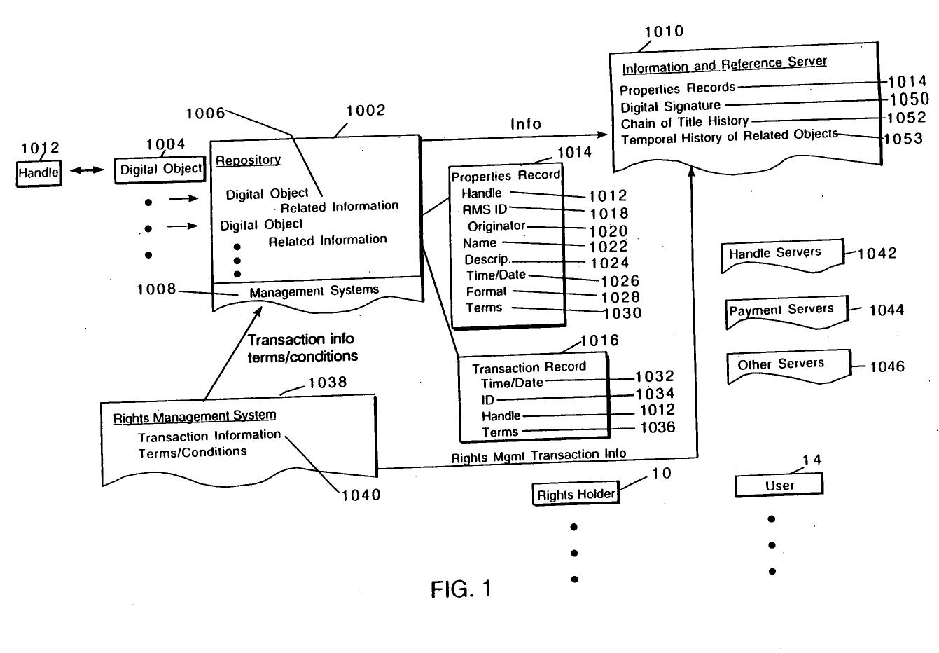

FIG. 1 is a block diagram of a system for managing digital objects.

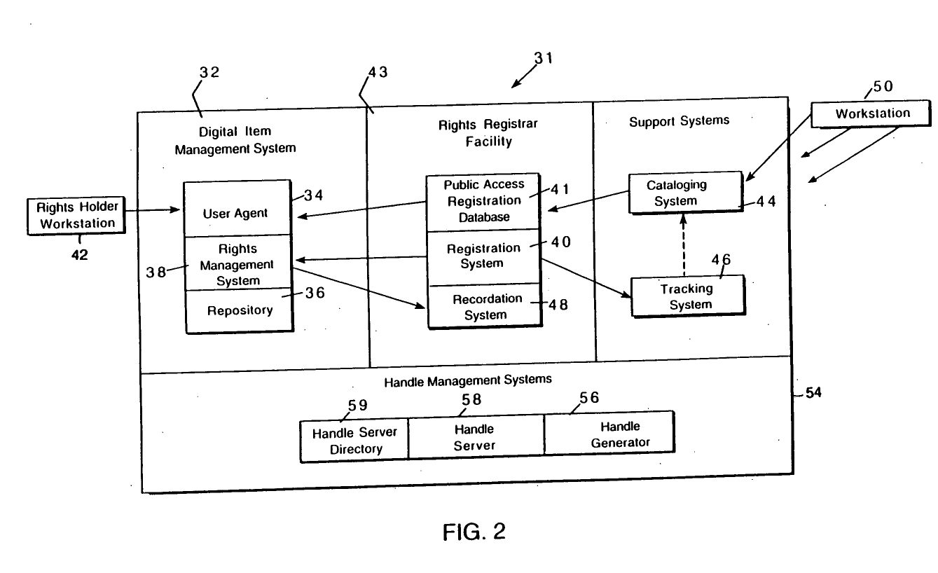

FIG. 2 is a block diagram of an example of a system for registration of rights, recordation of transfers of rights, and rights management.

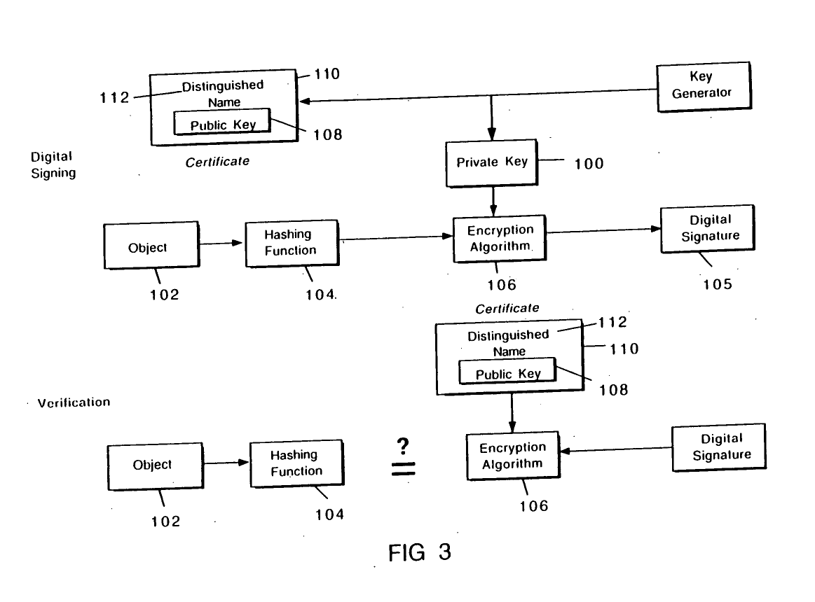

FIG. 3 is a block diagram of digital signing and verification processes.

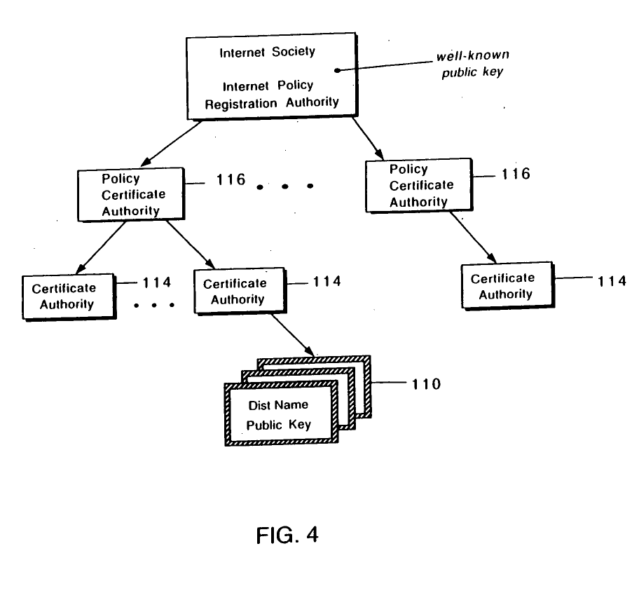

FIG. 4 is a block diagram of a public key distribution arrangement.

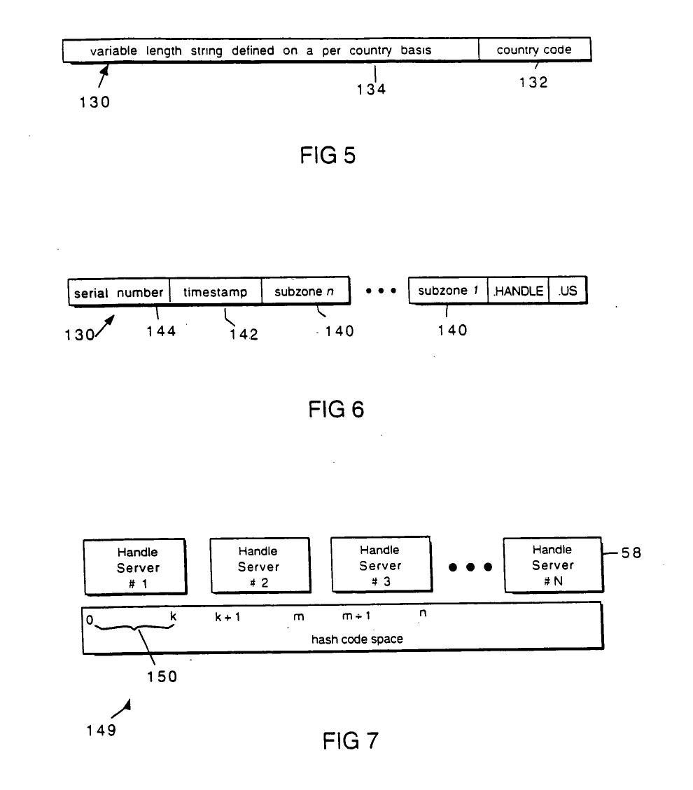

FIGS. 5 and 6 are diagrams of handles.

FIG. 7 is a diagram of hash code space.

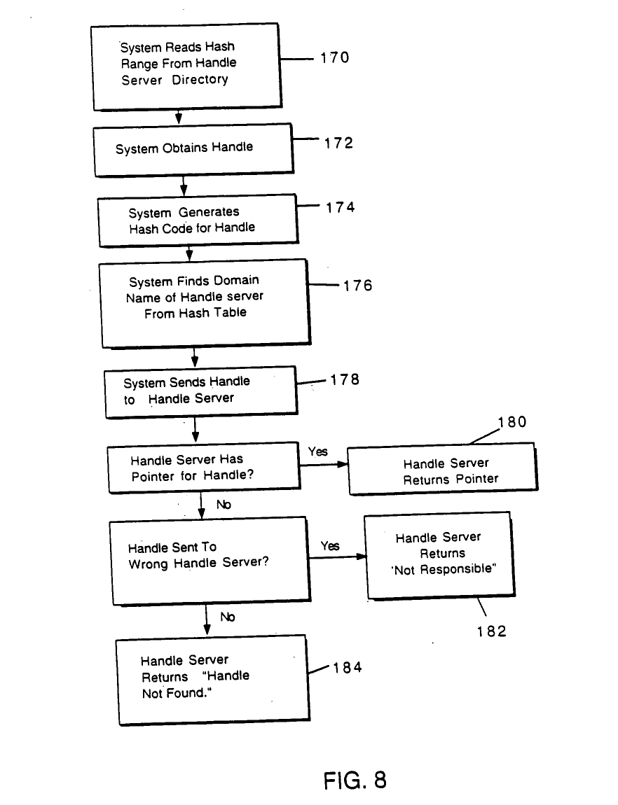

FIG. 8 is a flow chart of handle processing.

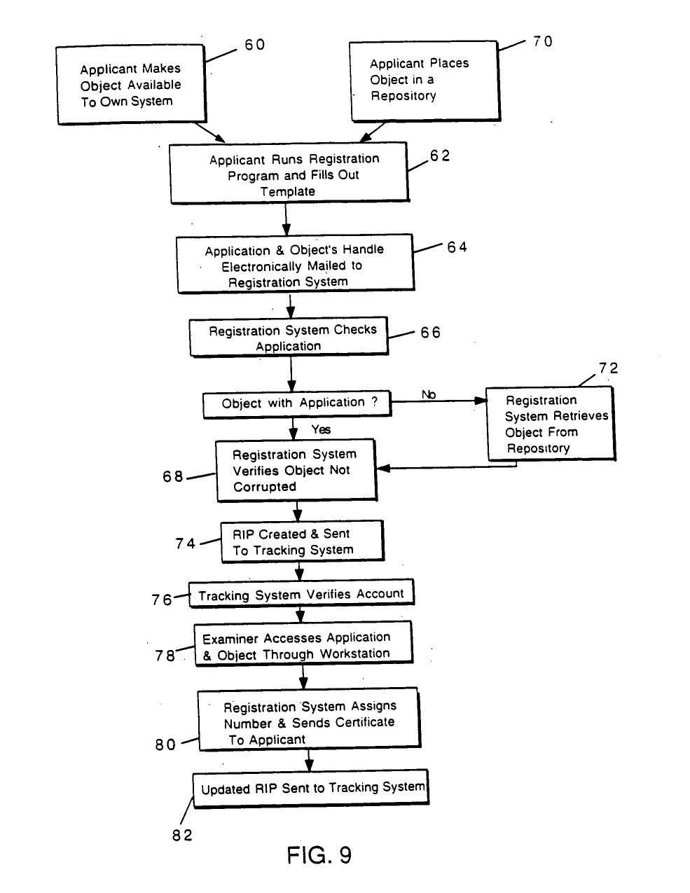

FIG. 9 is a flow chart of a process for applying for rights registration.

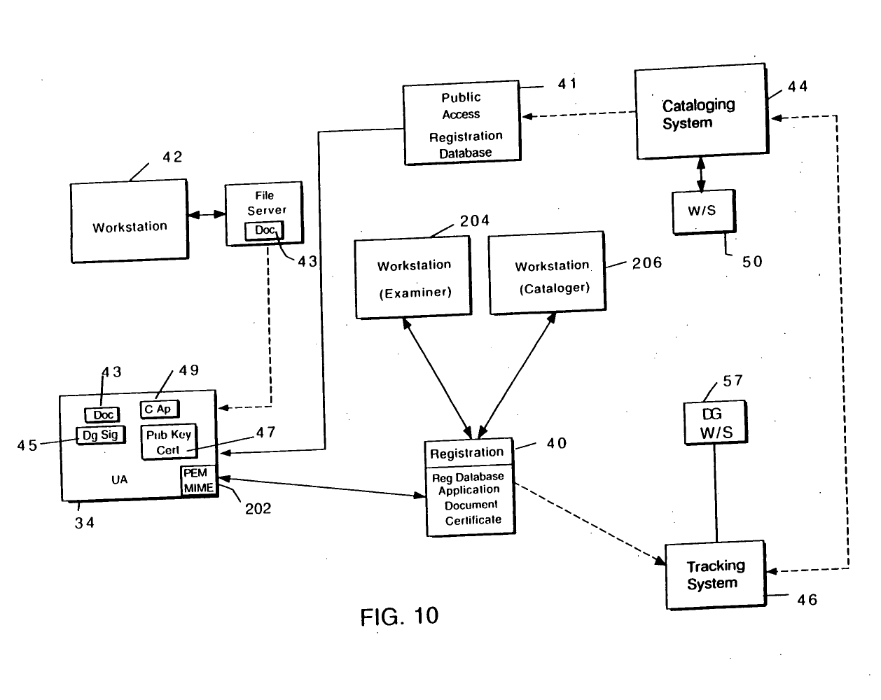

FIG. 10 is a block diagram of portions of the system.

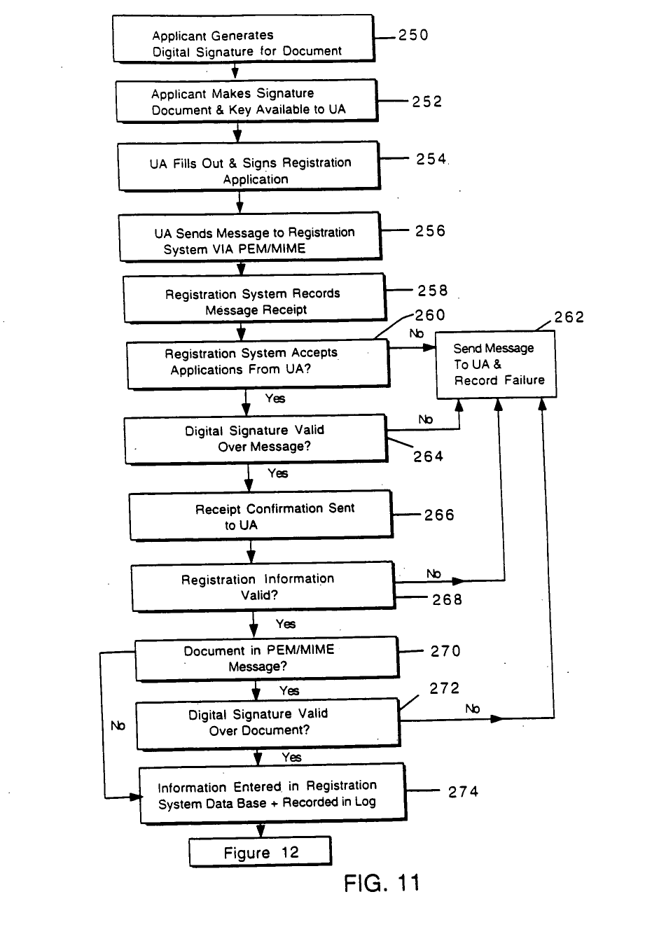

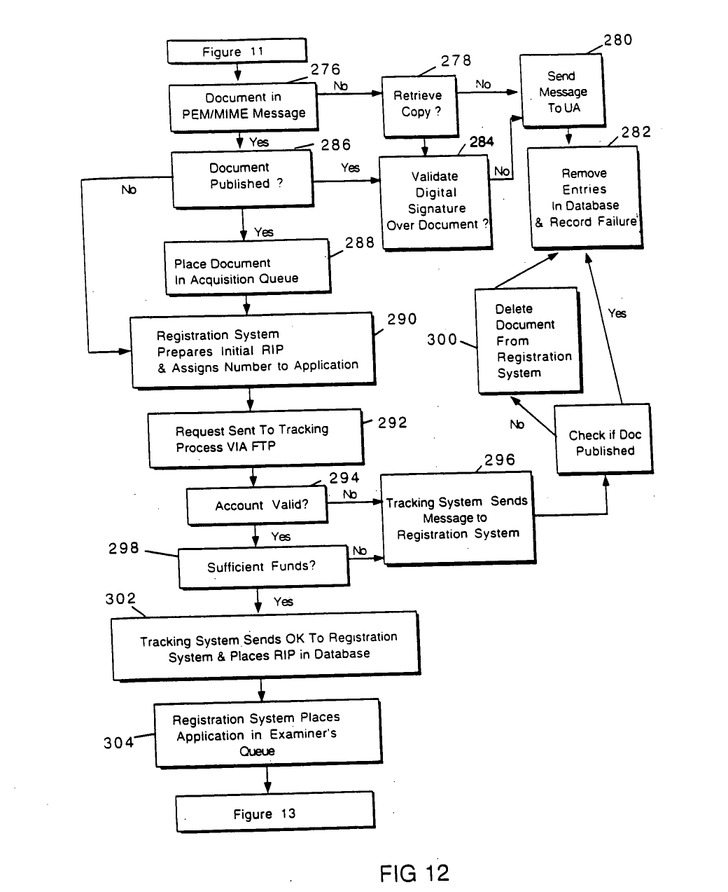

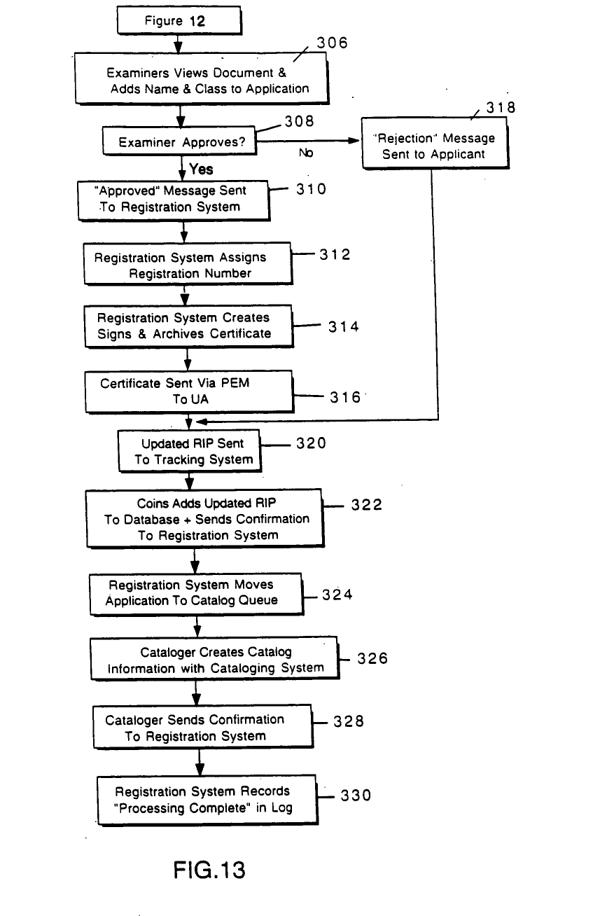

FIGS. 11 through 13 are flow charts of a registration process.

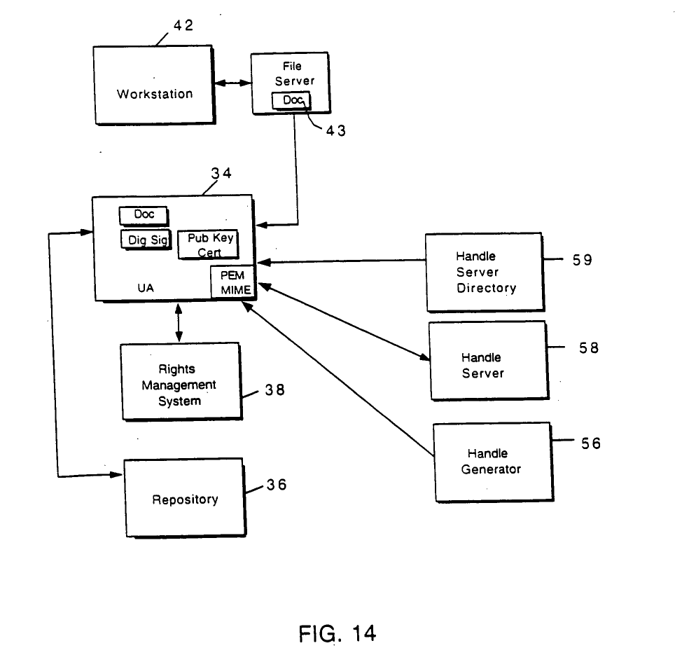

FIG. 14 is a block diagram of portions of the system.

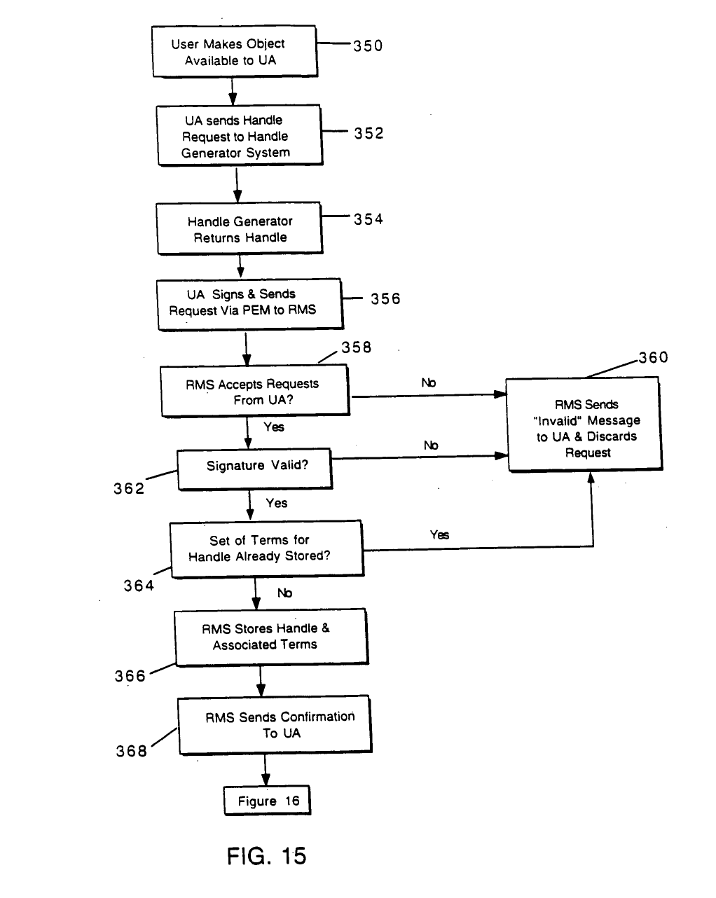

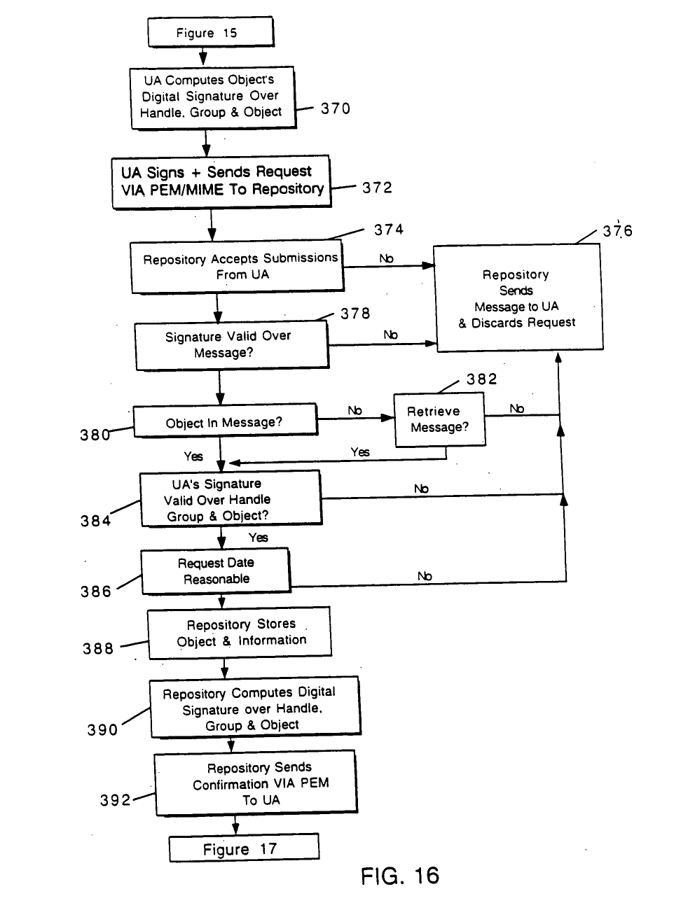

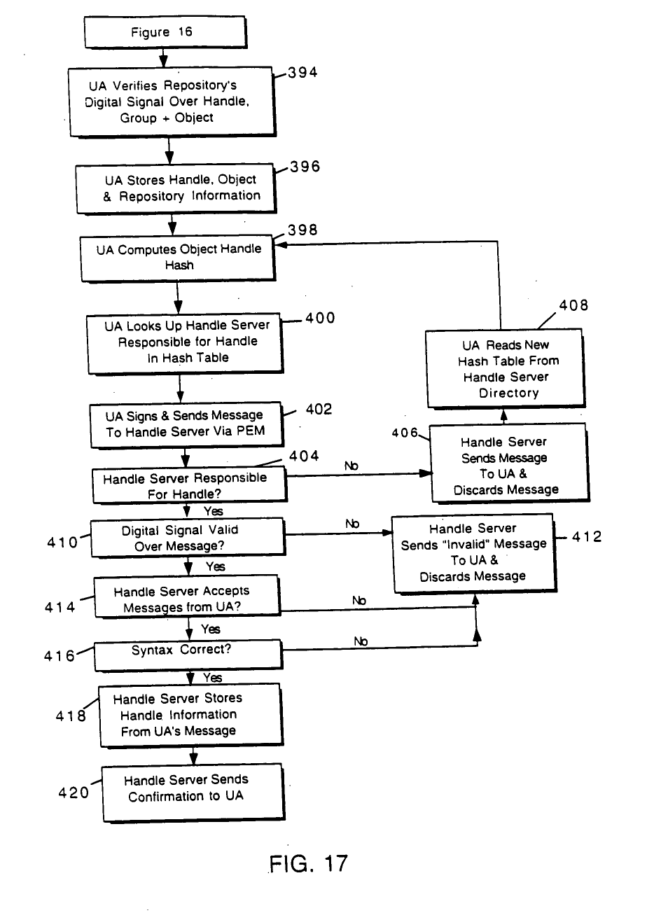

FIGS. 15 through 17 are flow charts of a process of depositing an object in a repository.

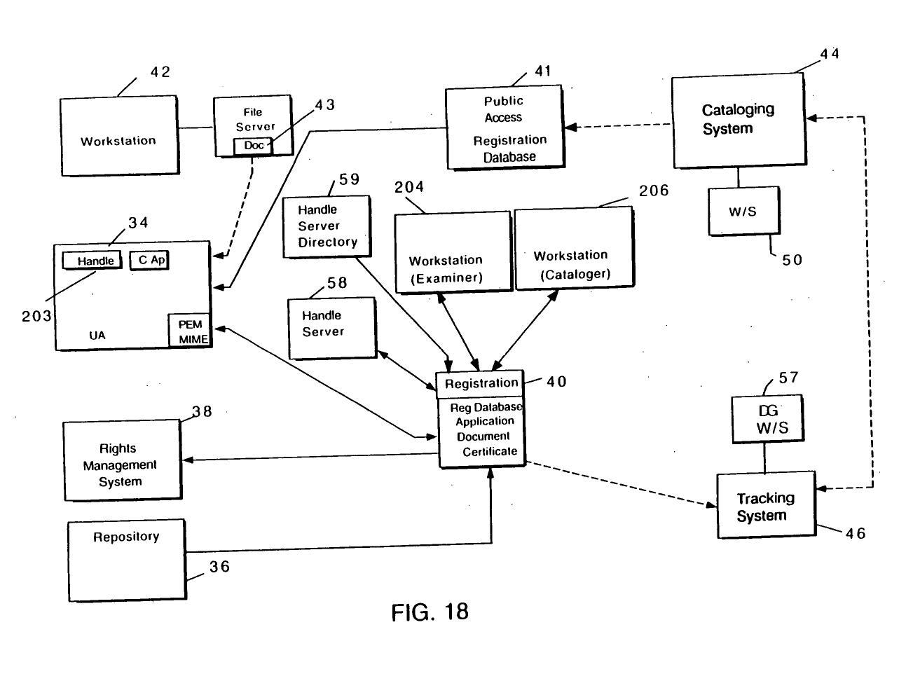

FIG. 18 is a block diagram of portions of the system.

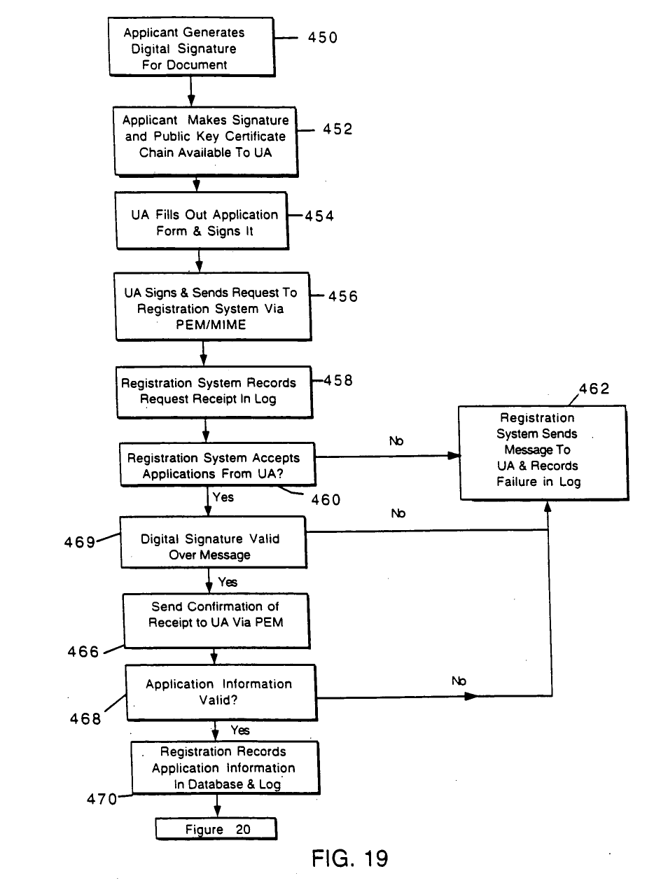

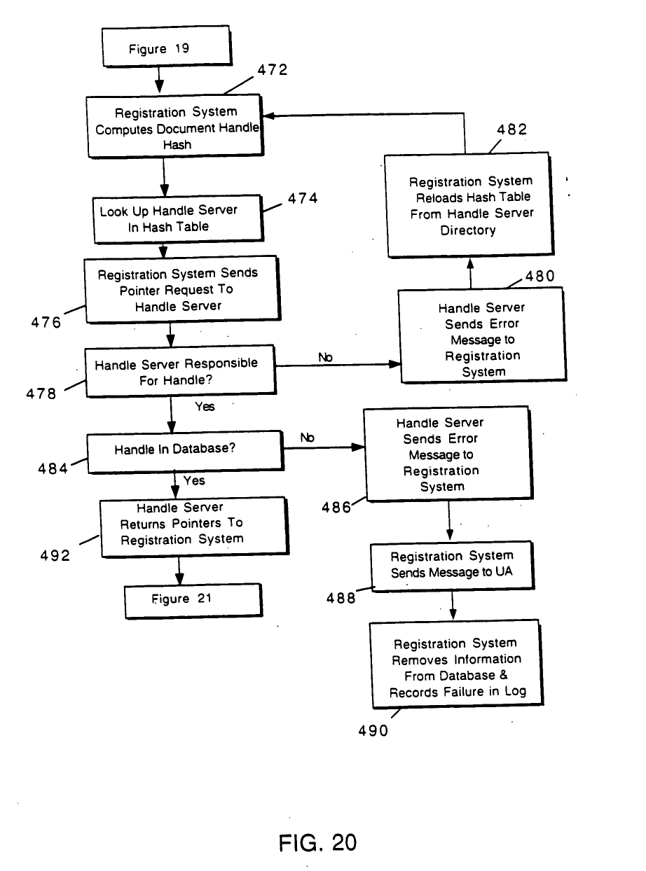

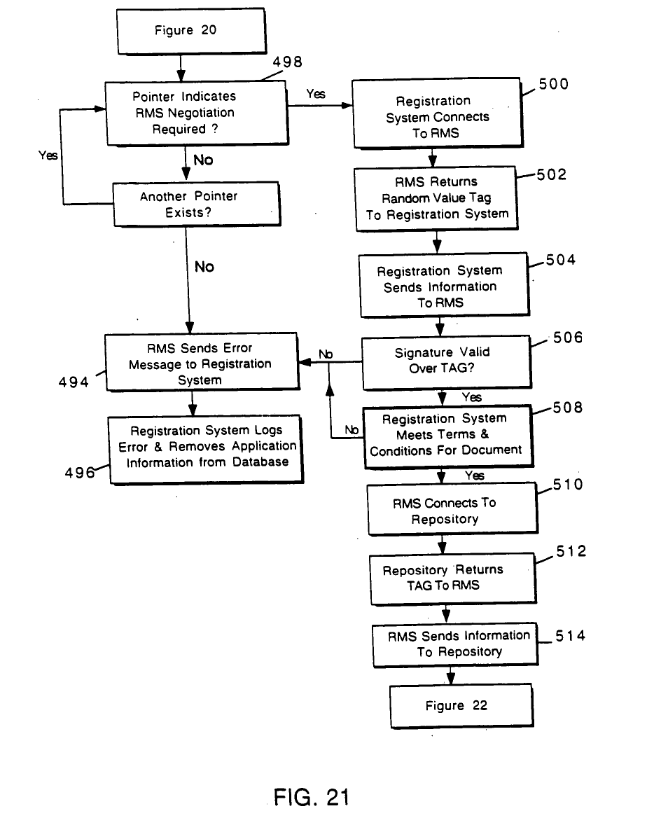

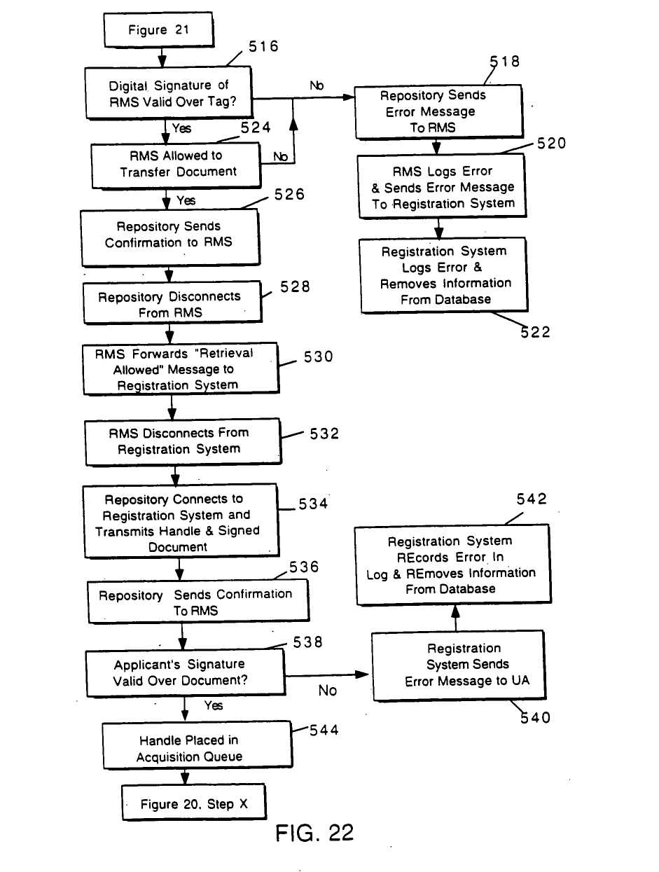

FIGS. 19 through 22 are flow charts of a registration application process.

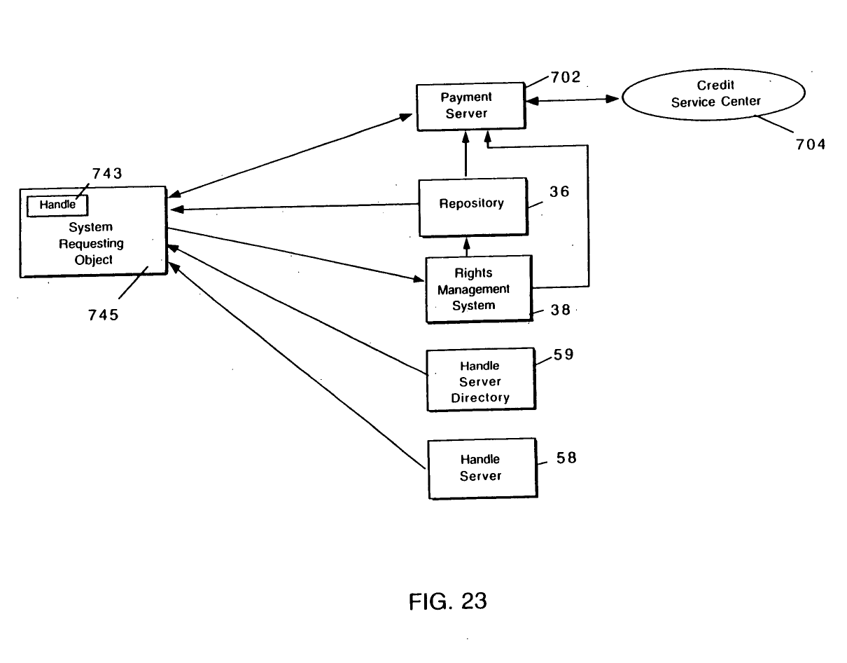

FIG. 23 is a block diagram of portions of the system.

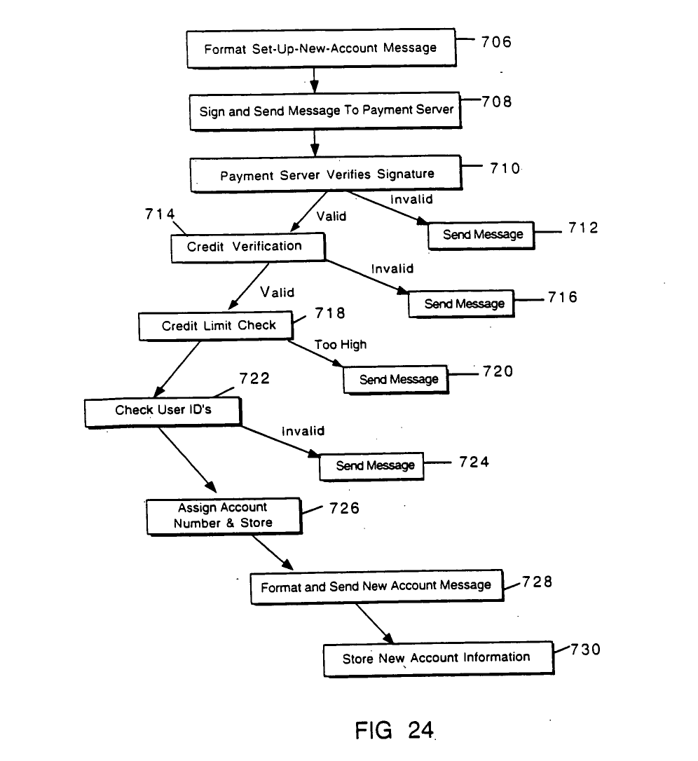

FIG. 24 is a flow chart of a process of setting up an account.

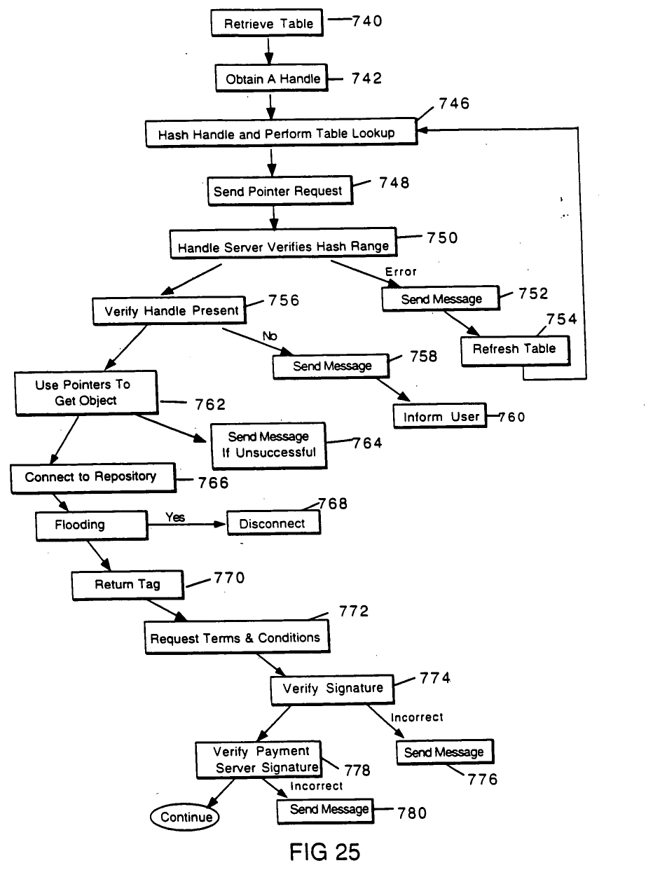

FIGS. 25, 26, and 27 are flow charts of processes of retrieving an object.

FIG. 28 is a schematic diagram of repositories and naming authorities.

FIG. 29 is a diagram of a composite digital object.

FIG. 30 is a diagram of a repository and repository access protocol.

FIG. 31 is a diagram of a service request program of a repository access protocol.

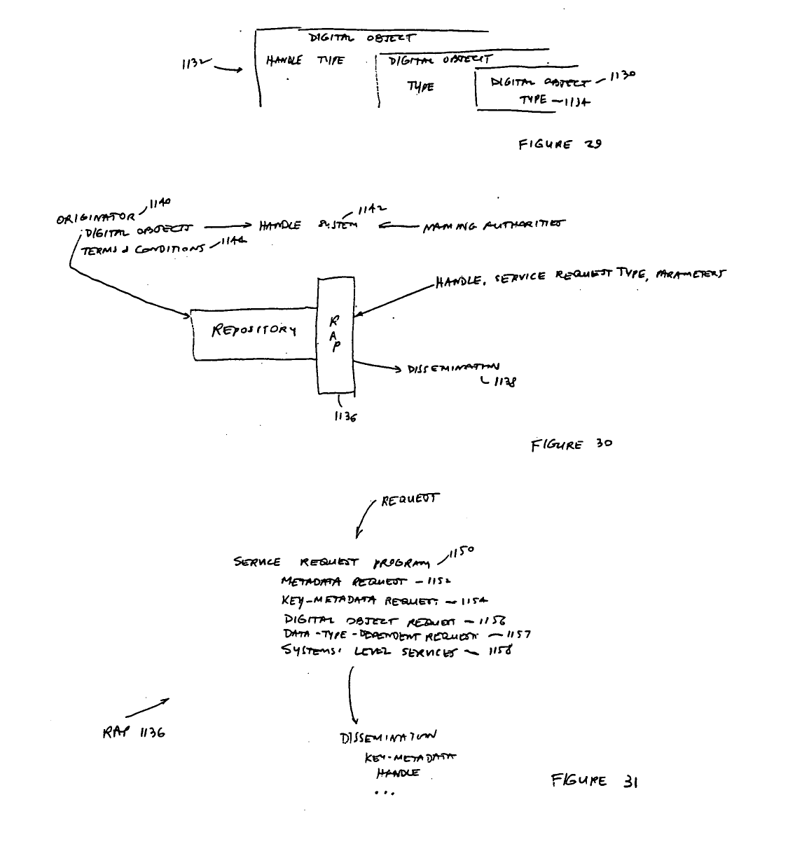

FIG. 32 is a diagram of a handle.

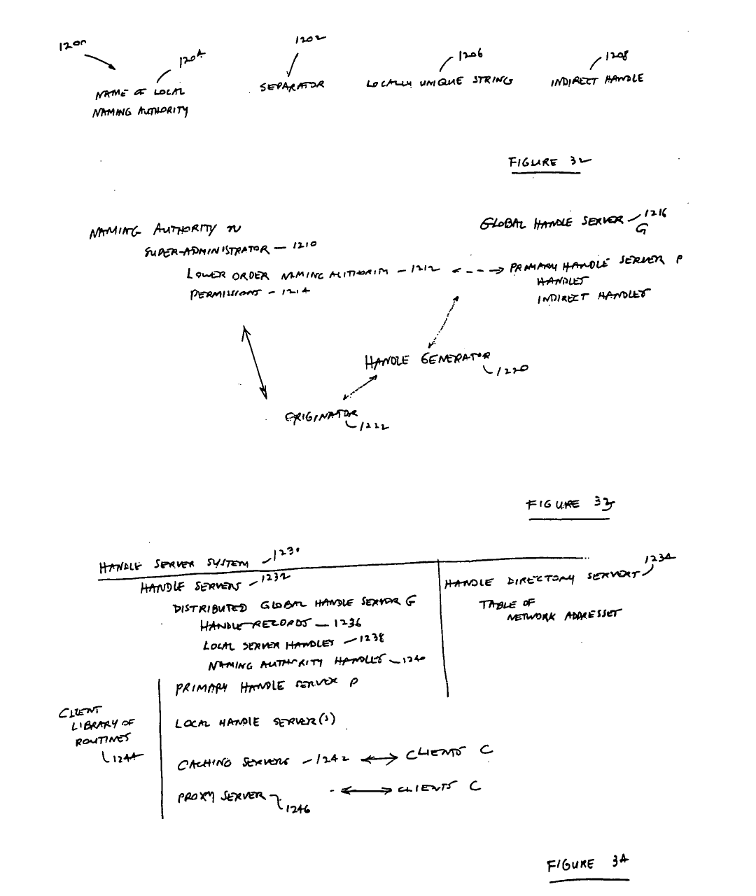

FIG. 33 is a diagram of portions of a handle system.

FIG. 34 is a diagram of a handle server system.

Preliminarily we define several terms and concepts which are used in the following discussion (see FIG. 1).

Formally, a digital object is an instance of an abstract data type that has two components, data and key-metadata. The data is typed as described below. The key-metadata includes a handle, i.e., an identifier globally unique to the digital object; it may also include other metadata, to be specified. Possible primitive and composite data types for digital object data are discussed below.

A “repository” 1002 is a digital storage system into which digital objects 1004 may be placed and retained for possible subsequent retrieval. The repository may contain other related information 1006 as well as management systems 1008. Where appropriate, such information may be provided to an “information and reference server” 1010. The repository has mechanisms for adding new digital objects to its collection (depositing) and for making them available (accessing), using, at a minimum, a so-called repository access protocol. The repository may contain other related information, services and management systems. The result of retrieving a digital object from a repository may be a performance of the digital object (e.g., execution of a program) or the digital object itself (e.g., the program). This is important in the case of digital objects which are only intended to be performed by users (e.g., a video game) rather than making the object itself available. A performance of a digital object may be stored as a new digital object and there may be separate terms and conditions associated with it. A repository itself may be considered as a kind of executable digital object whose meta-date is ACCESS REF (see below) and whose command language is RAP (see below). Thus every repository may be considered a compound digital object.

A “stored digital object” 1122 is a digital object stored in a repository. In addition, handles 1127 are expected to be made known to a system 1128 of “handle servers”, as described below. Such a handle is a “registered handle”. A “registered digital object” 1124 is a stored digital object whose handle has been registered. (Note that a handle is normally registered at about the same time that its corresponding digital object is stored) Repositories provide users access to stored objects under terms and conditions that may be set by the depositor and/or a given repository.

Registered digital objects are entities of significance to the infrastructure, since they are stored in a repository and made known via the registration of their handles. Intermediate entities, such as stored digital objects, are defined because they may arise in implementations of repositories that provide access to registered digital objects. However, their existence is not strictly necessary. For example, a repository may offer a service in which it deposits a digital object and registers the handle simultaneously, therefore creating a register d digital object without creating a prior stored, but not registered, digital object. (It is possible, of course, to create other useful classes of digital objects. For example, we may define a proposed digital object as a digital object whose handle field contains a string that has not yet been registered and whose uniqueness may not yet be known.)

Concatenated and Composite Digital Objects

Digital objects are “typed”. Thus one can tell in a concatenated sequence of digital objects what each element of the digital object consists of and where each digital object starts and ends. One simple way to accomplish this is to include a type field as the first part of the sequence of binary digits which contains the necessary information. It could also be externally maintained (e.g., in a properties record 1014 in FIG. 1, described below). Data types assumed to be in the handles system include bit-sequence, digital-object, and handle, and also set-of-bit-sequences, set-of-digital-objects and set-of-handles. Other data types can be defined and made available to the handles system via the type construction operators set-of and compose; these types are then registered in a global type registry.

In contrast, one can create subtypes of digital objects by introducing new fields of metadata; these may be arranged hierarchically. For example, one might create a subtype of digital object called computer-science-technical-report which has metadata for author, institution, series, and so forth.

As seen in FIG. 29, a digital object may contain other digital objects in the sequence of binary digits following its handle. A user will be able to identify these contained objects from the type fields 1134 of those digital objects 1130 contained therein. We shall informally refer to digital objects whose data is a set, one of whose elements is of type digital-object, as “composite digital objects” 1132. A digital object that is not composite is said to be elemental. (Note that this definition explicitly excludes the application of the adjective composite to a digital object whose data is another digital object, i.e., whose data is of type digital-object, as distinguished from a singleton set of this type. Nothing precludes the existence of such objects, however.)

The terms and conditions of a composite object may implicitly or explicitly be unioned with those of its constituent objects to arrive at the terms and conditions for those constituent objects. Terms and conditions may be explicitly imposed only on the composite object, in which case they would apply to each constituent object; or each constituent may have its own separate terms and conditions in addition. (Of course, creating composite digital objects may be subject to copyright and any other legal restrictions pertaining to its constituent objects.)

Properties Record and Transaction Record

A digital object may have associated with it, in the repository or elsewhere, as part of the related information 1006, a “properties record” 1014 which is a set of database entries that describe properties of the digital object.

A stored digital object also may have associated with it, in the repository or elsewhere, an associated “transaction record” 1016 which records transactions involving the digital object. The transaction record may contain entries such as the time and date of deposit of the object 1032, the time and date of each request for retrieval of the object, the identity of the requesting party 1034, the handle 1012 and service request for the object, and the applicable terms and conditions 1036 including amount and method of payment. Transaction records will only be made available to authorized parties. Repositories are not required to have transaction records persist for any period of time and may store transaction records at various times and places as deemed necessary subject to administrative controls.

The properties record comprises all metadata for a digital object, including its key-metadata, but also, other metadata the repository may maintain for that digital object. Notionally, the key-metadata component is a subset of metadata which is invariant for a digital object over repositories. No restriction is implied on how much of the metadata should be included in the key-metadata, other than requiring that it include a mandatory handle. Possible examples of repository-dependent metadata are the general terms and conditions for access and usage of the digital object, and the date and time of deposit.

The properties record may contain entries such as the identity of a rights management system 1018 (i.e., the system that has control over transfers of and compensation for rights in that object), the handle 1012 for that object, the originator of the object 1020, the name of the object (if any) 1022, a description of any work or other information or material incorporated in the object 1024, the time and date of deposit 1026, format information 1028, and stated terms and conditions for access and usage of the object 1030. The terms and conditions in the properties record may allow the user to select which type of action to allow (e.g., retrieve object or perform object). The user may be allowed to negotiate type of action with the RMS. The user also may be given no choice of options. In many retrieval cases, the user will not know if an option exists.

The properties record, the transaction record, and the digital object all are normally accessible using the handle.

A digital object's data may incorporate information or material in which copyright, design patent or other rights or interests are claimed. There may also be rights associated with the digital object itself. An author may have submitted a digital object for purposes of registering a claim to copyright in a work that may be incorporated in the object. Since the copyright pertains to the underlying work fixed in the form of the particular submitted representation, the rights would normally pertain to all representations of the work, including, but not limited to, those representations of the work that are contained in other digital objects.

The entities discussed thus far give users a number of means to include digital objects that contain or may be interpreted to manifest the same or similar information or material. As an example, a literary work may be fixed in a number of different formats, e.g., LaTex, PostScript and GIF page images. Each fixation may correspond to a distinct (elemental) digital object, each with its own unique handle, and other metadata. A composite digital object may then be created whose data is the set of these digital objects. Similarly, one could create a composite digital object whose constituent objects were the fixations of the literary works of Shakespeare in PostScript. The handle of this composite digital object, in effect, names the PostScript collection of Shakespeare's literary works.

Note that it is possible to construct objects with similar effects without using composite digital objects. For example, the single digital object intended to correspond to a work could have data of type set-of-bit-sequences, rather than of type set-of-digital-objects, and contain each of the forms of fixation therein. In this case, digital objects may not exist corresponding to the individual fixations. Another possibility is to have a digital object whose data is of type set-of-handles. In this case, the handles would name the individual fixations (which may not even be available from the same repository). Such a digital object may contain other data fields that further describe (or annotate) the handles. Yet another possibility is to create a markup language which admits handles, plus other conventions for expressing how they relate to each other (for example, whether the individual handles are meant to be interpreted as different fixations of the same work, or a list of bibliographic citations, etc.) A digital object whose data comprise sentences in this markup language could serve to represent the same entities as do composite digital objects.

Meta-Object; Mutability

We use the informal term “meta-object” to refer to a digital object whose primary purpose is to provide references to other digital objects. Both digital objects whose data are of type set-of-handles and digital objects in a markup language that admits handles, would be instances of meta-objects.

A digital object may be mutable in that it may be changed after it is placed in a repository. Although none of the key-metadata may be changed, nor may any known digital object that it contains be changed (unless the original digital object is also changed), most other changes are permissible. Minor changes might be made to correct a misspelling or other such error; changes to the title of a mutable digital object may be permissible. A mutable composite digital object could be modified to add the representation of an underlying work in a new format. Mutability would also be a useful way to allow digital objects that are designed to change with time or are dynamically computed.

A digital object that cannot be changed is said to be “immutable”. If an object is immutable, then, once it is placed in a repository, the result of all subsequent requests to that repository that are functionally dependent on the data of the object must be identical. (However, it may be possible to remove an immutable object from a repository, or deny access to it at different points in time.) That a digital object is immutable may be reflected in its key-metadata. It is also possible that a given repository may preclude changing a stored object by an indication in its non-key-metadata.

Once set, the mutability or immutability of a digital object cannot itself be changed. Users who wish to achieve a comparable effect would have to create a new digital object with similar data and altered metadata. The original digital object may then be withdrawn or not, as desired or appropriate.

Rights Management System

The “rights management system” 1038 is a system used to negotiate access rights and other rights not otherwise specified in the properties record. It retains information about transactions, and communicates information about approved transactions and associated terms and conditions to the repository. Where authorized, it also informs the information and reference server about transactions involving rights management for recordation purposes.

The information and reference server 1010 receives information from the repository and the rights management system. It retains a copy of the properties record for each digital object, a digital signature or other “fingerprint” of the digital object (the digital signature and other fingerprint is typically considerably smaller than the object itself) suitable for verification purposes, and a temporal history list of related objects. In retains a history of chain of title 1052 to digital objects. The information and reference server is intended to be used for browsing, verification purposes, and to alert users to changes in the system. In some implementations it can be used as a registration and recordation server for copyright and other purposes. The server may be part of a governmental department, or of a private service operation. The information and reference server typically would not retain complete digital objects for storage and retrieval purposes.

The network would also be accessible to a wide variety of rights holders 10 (e.g., authors, owners, holders of exclusive rights). The rights holders may have access, when authorized, to the information and reference server, the repositories and the rights management system. The information and reference server, the repositories, and the rights management system are also potentially accessible by network users 14, who may wish to obtain, use, modify, transmit, perform, and enhance selected digital objects, or the results of operations performed by or on digital objects. The medium of the network (e.g., the cables, airwaves, public switched telephone network) is not shown in the figure; but the network medium could be organized as a single local area network, a wide area network, or a broader network structure (e.g., the Internet).

Originator

An “originator” 1140 is an entity that authorizes or validates a set of digital objects (e.g., a series of reports from the Computer Science department of a university); it is responsible for each such digital object including deciding to make it available in the handle system 1142 and defining terms and conditions for its use. Every digital object has an originator, which may be an individual or an organization. Originators may deposit and withdraw the digital objects they authorize or validate and may authorize others to do so (this also includes the right to withdraw or modify the objects), subject to the procedures established by individual repositories. Naming authorities have the right to insert handle entries for handles they generate into the handle server system and to authorize others to do so. A naming authority administrator would typically make these insertions. An originator and/or a naming authority may also delegate this authorization ability to others (typically this would be to one or more repositories) Such delegation includes at least the right to authorize the further deposit of digital objects on behalf of the originator and insertion of designated groups of handles on behalf of the naming authority. Repositories may establish additional requirements of various kinds.

Repository of Record

The initial repository used to deposit a registered digital object is designated the “repository of record” (ROR). The ROR is responsible for authorizing additional instances of the digital object at other repositories, and for making changes or withdrawals of such additional instances of the digital objects, usually upon the direction of the originator. Once designated, the ROR may subsequently be changed by an authorized party to another repository, but the method for achieving this is not specified here.

Each digital object has a “handle”, a concise unique identifier for a digital object used for storage and retrieval operations and other repository functions.

The overall system also includes a handle management system 1042 (FIG. 1; also seem on FIG. 2) comprising multiple servers which provide handle server directory services, handle-to-pointer translation services (called “handle servers”), and handle generation services; payment servers 1044 which provide payment authorization services; and a wide variety of other possible servers 1046 including those which would provide intermediary services between rights holders and users, on one hand, and other servers on the other hand. For example a server might provide a service of receiving a conventional bibliographic citation to a journal article and communicating with an appropriate handle server to identify the location of the article on the network. That service and others could be provided as commercial services. It should also be clear that services can be provided on a widely distributed basis by multiple similar servers at different locations on the network, or by single centralized servers. Furthermore, not all of the digital objects which may exist on the network need be covered by the servers of FIG. 1. Only when rights holders choose to subject their objects to the system would the services need to be provided.

There is no requirement that a digital object be stored in a repository in any particular manner. Conceptually, the description of a digital object is strictly a logical one and is not intended to describe any particular implementation. In particular, it is possible that, in response to a request to access a particular digital object, a server runs a program that computes the digital object on the fly. It is possible for multiple digital objects to be embedded in a program (e.g., a data base manager or knowledge based system) that emits them upon request. The program may itself be a digital object. Thus, accessing and depositing are virtual processes, and may or may not involve the actual depositing and retrieval of actual objects per se, although such actual storage and retrieval is likely to be prevalent.

Repository Access Protocol (RAP)

A “simple repository access protocol” (RAP) is supported by each repository and discussed below. The RAP may be merely a subset of a larger interface protocol used by repositories, provided that the functions or operation of the RAP not be affected by any implemented supersets of the protocol. In particular, as seen in FIG. 30, the RAP 1136 allows for accessing a stored digital object or its metadata by specifying its handle, a service request type, and additional parameters. If this request is complied with, the output of the service request is termed a “dissemination” 1138. A dissemination is the result of an access service request, along with additional data affixed to it.

Access to a Digital Object (ACCESS DO)

Access to a digital object will generally invoke a service program 1150 that performs stated operations on the digital object or its metadata depending on the parameters supplied with the service request. Defined service requests include metadata 1152, key-metadata 1154 and digital object 1156; the first requests only the metadata, the second only the key-metadata, and the latter, the entire digital object (i.e., the key-metadata and the data). Other systems-level services 1158 may be defined. Possible examples of such additional services might be encrypt, i.e., return the digital object in some encrypted form, or compress, i.e. store a fewer set of bits than supplied with the property that the original bits can be regenerated, perhaps exactly.

In addition, it is possible to have data-type-dependent service requests 1157. Possible examples of such data-type-dependent services requests might be execute (for digital objects a portion or all of whose data component is of type program), or subpart (which requests only a component of the data or metadata of the digital object, further specified by some parameter). When a digital object is accessed via ACCESS_DO, the recipient receives a dissemination, that is, the result of the service request, along with information such as the key-metadata of the digital object, the identity of the repository, the service request that produced the result, the method of communication (if appropriate) and a transaction string corresponding to an entry in the transaction record. The transaction string is unique to the repository. In addition, the dissemination may contain an appropriately authenticated version of some portion of the properties record for that object, including the specific terms and conditions that apply to this use of the digital object and the materials contained therein.

As noted above, depending on the nature of the ACCESS_DO service request, the dissemination may not be stored as a digital object per se. It might instead include data that is not contained in any registered digital object, such as a portion of a digital object's data, the digital object data in a compressed format, or the result of executing the data of the digital object. In all cases, however, the key-metadata (including, of course, the handle) of the digital object is included.

From a copyright perspective, if the service request produced a dissemination that was derived from a particular digital object, the digital object may be contained in the dissemination, in the sense that the dissemination may be encumbered by the rights associated with the digital object. For example, if the data of a stored digital object represents an episode of a television program, and the dissemination contains the data corresponding only to the first two minutes of this television program, the dissemination may be said to contain the digital object in a legal sense, even if it does not properly contain all of its data in a technical sense.

Deposit of a Digital Object (DEPOSIT_DO)

Several forms of DEPOSIT_DO are possible. For example, one form may take data, a handle, and perhaps other metadata as arguments, and produce a stored digital object and properties record from these arguments. Another possible form may take a digital object as argument, perhaps with additional metadata, and simply deposit it. Yet another form may take only data and certain non-key-metadata, and automatically request a handle from a handle server, and then simultaneously store the object and register the handle.

The DEPOSIT_DO command may be used to replicate an existing digital object at additional repositories. A DEPOSIT_DO command may also be used to directly modify an existing mutable digital object. Alternatively, a modified version of an existing digital object may be stored as a new digital object rather than by modifying the existing one.

Access to Reference Services (ACCESS_REF)

This command provides a uniform and understood way to identify alternate means of accessing a specified repository and/or information about objects in that repository. Two possible responses are (i) No information, and (ii) a list of servers, protocol-name pairs, with the interpretation that each server, speaking the named protocol, will provide information about the contents of the repository. (That is, we provide a means of allowing a repository to have its contents indexed, queried, or otherwise described. It is possible, for example, that a repository will be its own provider of information about its contents, and list only itself, and some protocol, as the information provider about its contents. However, it is not required that any accounting of the contents of a repository be available, or that it be available from any one service. This is because we do not require that repositories per se correspond to coherent collections, which may be distributed across independently operated repositories.)

The RAP has been kept simple; more complex transactions may be assumed to be handled by other protocols, or by subsequent extensions of the RAP. In the first case, a primary use of the RAP for more sophisticated repositories is to have it present the other protocols that it supports (e.g., Z39.50, SQL3, ZQL, Dienst) as alternative access methods.

It may be desirable to extend the RAP in any number of ways, for example, to explicitly include, for example, a payment mechanism or a negotiation mechanism or a more sophisticated interactive model-based interaction mechanism.

Tools for Administration of Handles

Administrative data is stored in each handle record as a special data type. Access to this data is governed by access permissions specified for each handle separately.

Administrative tools are provided for creation of naming authorities; for creating, modifying, and deleting handles; for changing access permissions by individual or by group.

Two sets of tools are currently provided. The first uses electronic mail. The only security is to check the “from” field in the e-mail header. The second uses forms described in a markup language such as HTML. Security is by ID and password, or for greater protection may use public key encryption.

The handle system is based on the UDP datagram protocol. This enables a large number of transactions to be handled efficiently, but some security firewalls reject UDP packets. Therefore, the choice of UDP or TCP is provided as alternatives for the local handle server, caching server, client library, and the global handle server.

Overview of an Example System

In what follows, we provide examples of operations which may be conducted with assistance of the servers and services of the kind shown in FIG. 1. The operations include registration of rights, recordation of transfers of rights, deposit of objects in repositories, generation and use of handles, arranging compensation for use of objects and for licensing and transfer of rights (e.g., exclusive rights) in objects (under simple or non-simple terms), use of digital signature and other protective mechanisms to insure the integrity of the transactions within the system, management of rights, and obtaining objects from repositories.

As seen in FIG. 2, an example system 31 includes a digital object management system 32 which includes hardware and software to create and store digital objects and manage rights to the objects. In the system, a user agent (UA) 34 provides a user interface for interactions with other elements of the system. The UA is in the form of software running on a workstation. The UA may be used to initiate storage of an object within a repository 36 by passing the object to the repository or by transmitting information which the repository can use to retrieve the document. The UA also interacts with the repository to initiate a rights registration application process.

The UA also interacts with a rights management system (RMS) 38 to initiate recordation of transfers of rights. The UA interacts with the registration system 40 directly (or indirectly through the repository) to initiate the rights registration application process and with the public access registration database 41 to allow users to browse and search for information about registered rights. System 40 and database 41 are part of a rights registrar facility (and serve as an example of the information and reference server of FIG. 1).

Rights holders may prepare digital objects for entry into the system using a workstation and file server 42 which transfers objects in any of several well known formats (e.g., ASCII or Group IV facsimile) to the workstation hosting the UA for rights registration application processing.

The RMS 38 provides information about terms and conditions for use of digital objects and enters into negotiations with users for rights. The RMS interfaces with the information and reference server to obtain relevant reference information. The RMS also controls conditions for access to objects stored in repositories. The RMS may delegate to the repositories the responsibility to handle simple terms and conditions. The repository 36 holds copies of digital objects in a secure and verifiable manner and controls access to the objects. The repository also sends copies of digital objects to other systems when instructed to do so by an RMS.

In the rights registrar facility 43, the public access registration database 41 will provide access to information about registered rights and provides a read-only interface to a cataloging system 44. The registration system 40 holds digitally submitted rights registration applications during application processing. The application information is submitted to a tracking system 46 for tracking purposes (e.g., for tracking examination or status) when the digitally submitted application is received. The recordation system 48 stores and provides information about transfers of rights (and other information pertaining to rights and interests. The recordation-and registration systems in this example form part of a more general information and reference service.

The cataloging system 46 stores information about registered rights and provides the basis for public (network) access to registration information.

A registrar workstation 50 allows a registrar user to view and print rights registration applications and accompanying documents and recordation information and accompanying documents. The workstation interacts with the registration system to obtain registration application information, with the rights management systems and repositories to obtain digital objects whose rights are being registered, and with the recordation system to obtain recordation information and associated documents.

The handle management systems 54 are used to find the location of digital objects and the locations of each object's associated RMS. A handle for an object may be associated with zero or more object pointers. Object pointers contain location information for locating digital objects and/or associated RMSS. Each object may have an associated RMS which manages rights in the object on behalf of the rights holders.

Handle-generators 56 in the handle management systems 54 create the globally unique handles.

Handle servers 58 process handle query requests. If the handle which is the subject of the query is found by a handle server, the object pointers associated with the handle are returned to the requesting client. A handle server accepts a handle as input and returns a list of pointers associated with the handle, where each pointer={domain name of storage system (repository), domain name of RMS}. The domain name of the RMS may be null, e.g., if there are no terms and conditions stored in the RMS. The domain name of the storage system may be null if the rights stored in the RMS do not include obtaining a copy of the object, or if the rights apply to a “physical” object.

The handle server directory 59 allows users to find the correct handle server for processing a given handle. Users which obtain handles from servers associate them with digital objects. The handle server directory 59 distributes handles to handle servers based upon a hash of handles. The handle server directory provides a list of domain names of handle servers and identifies the set of hash values of handles which each of the handle servers can map to pointers. Each country has its own collection of handle servers and handle server directories.

In one example, the handle server directory 59 holds a table 149 which associates hash ranges 150 with domain names of handle servers 58 (FIG. 7).

Public Key and Digital Signature Technology

There are several security issues that the system must solve. The registration system must be able to verify the identity of the rights registration applicant. This is required since the applicant will charge the registration to an account, and it is also required for legal reasons.

When an object is transmitted to either the registration system or the repository, the recipient system must be able to determine that the object was not altered in any way. When an object is stored on a repository, the rights holder of the object must also be able to determine that the object was not altered by the repository in any way. Similarly, when an RMS tells a repository to send a copy to an object requester, the repository must be able to verify that a valid RMS is sending the command to the repository. When any correspondence is sent to the rights registration applicant from the registration system, the applicant must be able to determine that the registration system was truly the source. As objects and other information are transmitted between the various system components, the privacy of the information must be ensured.

The system uses available public key and digital signature technology to handle privacy and authentication in the system as follows.

In conventional cryptography, a mathematical function and a secret key are shared by parties who wish to communicate confidentially. Each message to be sent is encrypted using the function and key, and the recipients decrypt it using the same function and key.

In conventional cryptography the keys must be kept secret and must be distributed by secure means. The notions of two Stanford University researchers, Martin Hellman and Whitefield Diffie, opened up a new way of thinking about key management. One key could be made public (e.g. the one used for encryption) and the other key would be kept private. Anyone knowing the public part of a pair of keys could use it to prepare a message which would remain confidential until the person knowing the private key used it to decrypt the message. The public keys could be listed in public directories since knowing them did not help anyone decrypt messages encrypted using the public key.

Three researchers at MIT, Rivest, Shamir and Adelman, later developed a pair of functions meeting the requirements specified by Diffie and Hellman. These functions are now known as the RSA algorithms. There are also other known ways to implement public key algorithms.

Since either key of a public key cryptography pair can be used to perform the initial encryption, an interesting effect can be achieved by using the secret key of the pair to encrypt messages to be sent. Anyone with access to the public key can decrypt the message and on doing so successfully, knows that the message must have been sent by the person holding the corresponding secret key. This use of the secret key acts like a signature, since the decryption only works with the matching public key. If the public key for the sender is stored in a public directory, any recipient can verify the identity of the sender.

As shown in FIG. 3, the private key 100 can also be used to prove that an object 102 has not been altered by anyone after the object's rights holder (e.g., an author) has fixed the representation of the object. If the author performs a hash 104 over all of the object's bits, and then encrypts 106 the hash value with his secret key 100 to produce a digital signature 105, a recipient can decrypt the hash value, rehash the original object and compare the two hash values to ensure that the object has not been altered.

One problem that must still be addressed is knowing whether a public key 108 found in a directory for a given correspondent is valid or a bogus key inserted by a malicious person. One way to deal with this is to create certificates 110 containing the name 112 of the owner of the public key and the public key 108 itself. This certificate is signed with the private key of a well-known certificate signing authority 114, shown in FIG. 6. The public key of the signing authority is also published in a certificate which is signed by a higher-level signing authority 116. In essence, a hierarchy of certificate authorities has been created.

In order to make an object be private in an efficient manner, a combination of public key cryptography and conventional private key cryptography is used. Since public key cryptographic algorithms require a substantial amount of computing power, an object will initially be encrypted with a secret key algorithm, such as DES, which is computationally more efficient. The DES private key will then be encrypted with the public key of the recipient. This encrypted DES key will be sent to the recipient, along with the encrypted object.

Many of the object and information transfers performed in the system are provided by Privacy Enhanced Mail (PEM,) which was developed by Trusted Information Systems of Glenwood, Md. The PEM system (and other similar available systems) can provide message privacy and correspondent authentication. There are other systems Other messages will be sent between system components via direct connections (e.g., “TCP/IP”). The TISPEM library, developed by RSA, is used to provide message privacy and correspondent authentication.

Object Handles

We turn now to a move detailed discussion of the elements of the handle system.

Handles should be globally unique across the network and over time; should be essentially permanent, since rights on an object may last many years; should not have any location information encoded in the identifier's namespace, since an object may be located at multiple and changing locations over time; the identifier's namespace must be variable and unrestricted, since the number of digital objects created may be expected to increase; once a user acquires an object's identifier, he should be able use the handle to ascertain the current location of the object; multiple authorities should be able to generate the identifiers.

In addition, the following constraints on the use of an object handle are preferred: users of an object do not need to know its location, only its identifier; objects may be moved from one storage facility to another without affecting users; users should be able to choose object providers based upon the terms and conditions associated with an object, including its costs.

The authorization and rules for creating a handle are determined on a country-by-country basis. In one scheme, as seen in FIG. 5, handles are printable strings 130, having a country code 132 appended to a variable length string defined on a per country basis 134.

Within the United States, the variable length string could be generated in a form similar to a domain name within the Internet, FIG. 6. Authority zones could be established, and each zone authority could be able to assign handles directly or create subzone 140 authorities. A time stamp 142 and serial number 144 would be used to create a unique identifier within an authority zone.

More generally, as seen in FIG. 32, a handle consists of two logical parts, concatenated with an intervening separator character 1202. The two logical parts are: 1) name 1204 of a local naming authority, which controls the local handle generation process, and 2) a locally unique string 1206, which is assigned by (one of) its handle generator(s). An originator may ask a handle generator for a handle, or it may propose a local string to be used. The local handle generation process should insure that local strings are unique. Handles have no prescribed maximum length in principle, but there will be a default length in existence at any time which can be adjusted upwards if necessary.

Repositories 1102, 1104, 1106 (FIG. 28) have official addresses and may also have official, unique names 1108, 1110, 1112, assigned or approved to assure uniqueness by a global naming authority 1114 if desired. Typically, the global naming authority will apply a global naming mechanism 1115 and accordingly may approve a name submitted by a local naming authority 1116, 1118, 1120 after confirming that it is not being used. Or, if requested, the global naming authority could assign a unique name of its own choice. The local naming authority may use this name as the name of a repository, if it wishes. In addition, it may extend this name to create new names (using a local naming mechanism 1117) by suffixing the name with a “.”, followed by a new (relatively) unique name component. Each such name represents a naming authority and potential associated repository. (I.e., in general, repositories will have unique names of the form “X.Y.Z”.) Because the high-order part of the name is unique, there is no need for further consultation with the global naming authority to assure that the locally generated name is globally unique.

Note that a repository name is not necessarily the name of a particular host. For example, repository 1107 may correspond to a set of hosts at different physical locations.

One aspect of the global naming mechanism is the global naming authority which assures uniqueness of the left-most part of the handle name. The global naming authority normally approves names for local naming authorities when presented to them for approval, or may, if requested, generate and assign a unique name, and assigns these to local naming authorities for use by the handle generators they authorize. A prospective local naming authority may propose a name for itself to the global naming authority for validation and registration. A local naming authority, named, say, “X”, may create additional, derived naming authorities of the name “X.Y”, etc., each authorizing its own handle generator.

In addition to the first globally assigned component (e.g. “X”), each subsequent component field of a naming authority name (e.g. “Y”, or “Z”) must be non-null and not contain the character “.”. There may be other restrictions on the non-alphanumeric characters to be used in naming authority names. In particular, the default separator character is “/” (so, e.g., “X.Y/local-string” is a typical handle from the naming authority “X.Y”). Other separator characters, and a syntax for defining another separator characters, (from a restricted class of non-alphanumeric characters) may be defined, and may entail other restrictions on the possible characters used in naming authority names. e.g., a conceivable syntax is to specify a non-default separator by an initial non-alphanumeric character, so that “% X.Y % local-string” is a valid handle. Otherwise identical handles with different separators may be identical or distinct, escape characters for restricted characters may exist, and the separator characters may be restricted (e.g., whether “a/b” is a possible naming authority name that can only be used with a non-default separator). Initially, naming authority names could be issued conservatively, being restricted to alphanumeric characters. An indirect handle is a special type of data field that can be held in a handle record. The data field contains the address of a handle server, with a specific data type to indicate that this is an indirect handle. A handle server address is either an IP address or a domain name. One use of an indirect handle is to allow reorganization of handles amongst handle servers. Indirect handles are left as forwarding addresses.

Naming Authorities

The name of a naming authority, n, consists of one or more strings, separated by periods. Examples are:

berkeley.cs

cnri.cs-tr.technology

The high-order part of the name (“berkeley” in the first example) is issued by the global naming authority.

Example. The global naming authority issues the name “cnri”. Future naming authorities, created by cnri, might be “cnri.cs-tr” or “cnri.xiwt”.

As seen in FIG. 33, each naming authority, n, has at least one super-administrator 1210 who has full privileges for that naming authority 1212, including permission to create a lower order naming authority, n.n′, with its own super-administrator. This super-administrator creates permissions for administration of handles within that naming authority 1214, and can also create new naming authorities, n.n′.n″, and so on. Super-administrators can delegate privileges to other administrators, including the privilege of creating naming authorities.

Example. The super-administrator for “cnri.cs-tr” can create a naming authority “cnri.cs-tr.technology”.

Every naming authority has associated with it a primary handle server, denoted by P. When a new naming authority is created, the primary handle server is initially set to be the global handle server, G. Thereafter the administrator of the naming authority can designate any handle server as its primary handle server, P.

Whenever the naming authority, n, creates a handle, n/d, either the handle, n/d, is stored in P or an indirect handle is stored in P, indicating that n/d exists and pointing to a handle server that holds n/d. Thus the primary handle server of any naming authority has handle records for all naming authorities that the naming authority has created.

When a new naming authority, n.n′, is created, it is given a handle. The form of the handle is: n.n′. The data part is null. The data field of the handle record contains the address of the primary handle server, P.

The handle for the naming authority is stored both in the global handle server 1216 and in the primary handle server of n. Thus the global handle server has records for all naming authorities.

Handle Generators

The handle generator 1220 may be a person, an organization, or a fully-automated process running on some machine or a set of machines. An originator may control a naming authority, but there may be naming authorities that are not controlled by originators.

An originator may propose handles to be assigned to its digital objects. The handle generator need not assume any responsibility for insuring that a handle which it generates is associated with any particular digital object; that correspondence may be left to the originator.

When an object is deposited in a repository, the repository contains a copy of the object plus identification of certain simple terms and conditions for a obtaining a copy of the object and using it. The rights management system contains non-simple (i.e., requiring additional negotiation) terms and conditions for obtaining a digital object and using it, and could also contain simple terms. The pointer to the repository may be null if the object is not available on-line. Certain objects may be required to be persistent for legal and other reasons. The pointer to the rights management system may be null if only simple terms and conditions contained in the repository (or null terms and conditions) govern the use of the object.

Handle Servers

Handle servers have the following characteristics: a handle server holds pointers associated with a subset of all handles; handles are assigned to handle servers based upon hash values computed on the handles; handle servers are assigned ranges of hash values; the set of all hash values is partitioned among the set of all handle servers. This leads to a highly efficient and reliable mechanism for locating objects and from handles. Other less efficient or less reliable methods could also be used. Handle servers may be configured to broadcast requests for handles to other handles servers, further enhancing the reliability and effectiveness of the system.

As seen in FIG. 34, the handle server system 1230 includes handle servers 1232 and handle directory servers 1234 located at certain well known locations. The directory servers will maintain a table of network addresses of handle servers (generally, each handle server will contain such a directory). This table will generally be downloaded by each participating site frequently enough to be “acceptably” up-to-date at all times.

Global Handle Server

The global handle server is a distributed system that stores and resolves handles. It is publicly accessible. The system is highly secure, is fault tolerant, and designed to run continuously. The global handle server is denoted by G.

One function of G is to store handle records 1236 for items that must be retained over very long periods of time, such as copyright registration, or legal records. G also stores handles for all naming authorities and local handle servers.

G is a public service and any client can ask G to resolve any handle. Since the handles for all naming authorities and registered handle servers are stored in G, and G is public, the name of every naming authority, n, and its primary handle server, P, are public and available to all clients.

Local Handle Server

Local handle servers are a local option. They work in conjunction with the global handle server to store and resolve handles locally. They provide increased local control of handles, distribute the computing load between central and locally supplied equipment, and provide simple access controls to handle data. By storing individual handles on both a local and the global handle server, they can be used to back up each other.

Local handle servers can be created and operated by naming authorities or repositories. Other organizations, such as service bureaus, can also create and run local handle servers. For a local handle server to become a registered part of the overall handle system, it must be given a handle (by some naming authority). This handle is then stored in G, the global handle server.

Local handle servers are not public services. Permissions for a client to use local handle server to resolve a handle are set by the system administrators. Currently, the only such method of access control is by the IP address of the client that makes a query to the handle server.

Each local handle server is implemented as a set of one or more server computers. When several computers are used, handles are distributed amongst them using a hash table. For reasons of performance and reliability, data may be replicated across these computers, but this is hidden from client programs.

Caching handle servers 1242 also may be run at local workstations on behalf of individual users to store location information for frequently used handles.

Storing Handles

Naming authorities can choose to store the handles that they create on any handle servers for which they have access permissions, local or global. When a handle is stored in several servers, one is declared to be authoritative. This can be the global handle server, G, the primary handle server, P, or another local handle server, subject to the naming authority having administrative permission to store handles on that handle server.

G is publicly accessible for handle resolution. If a handle is stored in G, then any client can resolve it.

Handles stored on other handles servers can be resolved only by clients that have suitable permissions.

Example. The naming authority “cmu.cs.robotics” might choose G as authoritative for the handle to an important object, and also enter the handle in its primary handle server, P, for local use.

When n creates a handle, it makes a record in P, the primary handle server of naming authority n, with an indirect handle to each handle server that is able to resolve this handle. This indirect handle indicates that the handle exists and can be resolved by a query to the appropriate handle server. Access controls on P should be set so that any client with permission to query the handle server is able to read this indirect handle.

Example. The naming authority “cnri.cs-tr.technology” creates a handle “cnri.cs-tr.technology/d1” which is stored in the global handle server. An indirect handle is stored in the primary handle server indicating that a handle “cnri.cs-tr.technology/d1” is stored in the global handle server.

Resolution of Handles

The handle system provides a client library of routines 1244, currently written in the C programming language. They interface with the global and local handle servers and with caching servers. They can be included in client programs that wish to contact handle servers.

Caches are used by clients to reduce the load on the other handle servers, particularly the global handle server, G. Resolution of handles using caches is, in general, faster than resolution without caches. The caching server is a shared cache to be used by a group of clients. The architecture also allows a cache to be incorporated within an individual client.

The recommended configuration is for any client, C, to have an assigned cache, C1. This can be integrated into the client or can be caching server shared by several clients. C1, itself, may be connected to a higher order caching server, C2. To avoid resolution involving many steps, the recommended configuration is to have no more than two levels of caches, C1 and C2.

A proxy server 1246 has been developed that acts as a client to the handle system for use with Internet browsers and other clients. The client passes a handle to the proxy server which attempts to resolve it. If the handle can be resolved into one or more URLs, a URL is returned to the client.

The proxy server is configured as a separate server to be used by a group of clients. The recommended configuration is that every organization that wishes to use the handle system should provide both a caching and proxy server for its community.

We now describe how a client, C, resolves any handle, h. Note that (a) each handle server can be implemented as one or more server computers; (b) checks are required to prevent looping through indirect handles; (c) the client may not have access permissions for all local handle servers; (d) the client request may ask for all the data in a handle record or data of specified types only; (e) because the local handle servers are independently managed, the client may encounter inconsistent data or unacceptably poor response from a server.

If the client, C, is not attached to any caching server, it uses the following steps to resolve a handle, h.

1. C sends a query to G.

If the handle record for h is stored in G, G resolves h.

Otherwise, G returns the address of P, the primary handle server of naming authority, n.

2. If h is not yet resolved, C sends h to P.

If h is stored in P and C has the correct access permissions, P resolves h.

Otherwise, if there is an indirect handle to another handle server, M, which stores h, P sends the client the address of M.

3. If h is not yet resolved, the client, C, sends h to M.

If the client has the correct access permissions, M resolves h. (If C does not have permission, it should try other handle servers that hold the handle.)

If the client, C, is connected to a cache, C1, resolution of h follows these steps:

1. The client, C, asks C1 to resolve h.

If the handle record of h is in the cache, the handle record is returned to C.

2. Otherwise, if the identity of P, the primary handle server of naming authority n, is stored in C1, C1 resolves the handle following steps 2 and 3 above in the description of resolution without caching.

3. If the handle has not been resolved, and C1 is connected to a higher cache, C2, C1 asks C2 to resolve both h and P, and pass the results to C1 to be saved in C1's cache.

If h and P are not in C2's cache, the request is passed to the next higher cache, until the handle is resolved until the highest cache is reached. (The recommended configuration is to have no more than two levels of cache.)

4. If there is no higher cache, then the cache sends a request to G asking for the resolution of h and P.

The resolution algorithm then continues as in the description of resolution without caching.

The handle server system is intended to be a means of universal basic access to registered digital objects. In the worst case, a user can present a handle to a handle server and be advised of some repository which an authorized party has asserted contains the digital object designated by the handle. The handle server is not meant to be the only, or even primary, means, to locate repositories. Primary access may be provided locally and also by value-added service providers, likely in a variety of different and possibly incompatible ways. Users interacting with such services may not encounter handles; and such services may interact with repositories via RAP or via protocols that do not involve handles.

Handle servers provide a number of services, three of which are RESOLVE, INSERT, and DELETE. A party that is authorized to insert, delete and otherwise change handle entries for a particular naming authority is called a handle administrator. A naming authority may generally designate one or more repositories to act as handle administrators on its behalf. This designation will be made known by the naming authority to the handle server system.

Resolve

A handle is sent to a handle server to locate network names or addresses of repositories containing that object. The handle is first mapped to locate the handle server from the handle directory server table but is not otherwise interpreted. One can also supply a handle to a separate system, which invokes the above procedures to find the stated object. Local handle servers may use any technique to do the mapping. The handle servers maintained as part of the infrastructure map the handles by hashing them.

To resolve a handle, a handle server receives as input a handle and returns some or all of the fields of typed data in the corresponding handle record. The client can request that all data fields in the handle record be returned or only those fields that contain data of a given type.

No guarantee is made that the identified repositories will provide the designated object. Rather, the user is assured only that the specified repositories are where authorized maintainers of repository services have indicated particular digital objects reside.

Since a handle is just a unique string, it can be mapped to an actual repository by any of several mechanisms, including a mechanism that attempts to interpret the string. Repository names are not actual network addresses; they must first be mapped to network locations. The method for accomplishing these mappings is not specified. The handle service is one available means for both kinds of mappings; it would specify at least the location of the interface that supports the RAP protocol for a given repository. There may also be a need to explicitly provide a country identifier for repositories, naming authorities and/or originators. For the present, however, country identifiers are assumed to be omitted.

When a repository is identified by a handle server, it will be most efficient to map the handle directly into the network address (or addresses) of the repository. This mapping avoids having to do a double lookup from repository name to repository location. However, if the location of the repository were to change, the handle server would have to be notified so it could make the corresponding changes. It is possible that certain repository names may resolve to broadcast addresses to locate specific machines. This might be the case where a single repository consists of multiple machines on a local area network at a given site. The handle administrator may determine whether to store IP addresses or domain names or other information in the handle server. The entries are typed and therefore one or more of the above information types may be provided by the administrator for retention in the handle server.

Insert (Delete)

Information associating handles with network services are inserted into (deleted from) the handle server system by the handle administrator or other parties authorized by it. Such authorized parties include repositories of record. The repository of record is presumed to make known to the handle server system that it contains (or no longer contains) a particular digital object some reasonable time after the digital object is deposited in (withdrawn from) it. Similarly, the repository of record would make known to the handle server system the identity of other repositories which it authorizes to store a given digital object. The handle server system may perform certain administrative functions upon receipt of unauthorized requests. In addition, some form of reporting may be desirable to insure that entities that misbehave can be detected.

The handle server system is intended as a safety net of information about where digital objects reside. There will no doubt be other, valuable services that provide information to users about the location of digital objects in repositories.

We do not require repositories to provide a description of their contents. Repositories may not house coherent collections, and hence, querying or searching a repository may be a service appropriate only to the repository administrator, not to a user. Presumably, such capabilities will exist in the form of value-added services. It is such services, rather than repositories per se, that users would interrogate to identify digital objects of a certain nature. Such services may, of course, be offered by repositories themselves, especially in the case when one is intended to house a coherent collection. However, such a server is not a requirement of a well-behaved repository.

Obtaining Pointers from a Handle

Given a handle, the following steps, shown in FIG. 8, are followed to obtain a set of pointers associated with the handle.

In a first step 170, a client system downloads the table that associates hash ranges with handle server domain names from the handle server directory for future use. The client also can omit this step if it has previously stored the table; frequent changes in the table may necessitate doing this every time. In a later step 172, assume the system obtains a handle for which pointers are desired. The system then generates the hash code for the handle using a predetermined hashing algorithm (step 174) and consults the hash range/handle-server-domain-name table to determine the domain name of the appropriate handle server (step 176). The system subsequently sends the handle to the handle server as part of a request pointer information UDP packet (step 178).

The handle server then returns its response to the requesting system. If the handle server found the pointers, a list of pointers is returned (step 180). This could include pointers to use one or more repositories and one or more RMS's. If the handle was sent to the wrong handle server, it returns a not-responsible-for-handle message (step 182). In this case, the client system should download the hash range/handle-server-domain-name table from the handle server directory again and attempt the mapping again. The requester will determine how many times to try before giving up (and this same approach is used in other similar situations described below).

If the request was sent to the correct handle server, but the requested handle could not be found, the handle server returns a handle-not-found message (step 184).

Overview of Application for Rights Registration

There are two mechanisms used to register rights: an applicant may apply for a rights registration on an object which is located on his own system 42 or on an object which has been stored in a repository 36.

In order to submit and process a rights registration application the following general steps (described in more detail later) must occur.

First, as seen in FIG. 9, the rights registration application is created, and the application and the associated object are submitted to the registration system. The steps required to perform this depend on the location of the digital object. In registering an object which is located on the applicant's own system, the applicant first makes the object available to his own system (if it was created somewhere else) (step 60). The applicant then runs a rights registration program in a step 62, and he fills in a rights registration application template. The application and the associated object are electronically mailed (as a PEM message) to the registration system (step 64), which performs simple syntactic checking on the application (step 66), and verifies that the associated object has not been corrupted (step 68).

If the object has not yet been placed in the repository, the applicant first places the object in the repository (step 70). The applicant then runs the rights registration program, and he fills in the copyright registration application template (step 62). The application and the object's handle are electronically mailed (PEM) to the registration system (step 64), which performs simple syntactic checking on the application (step 66). The registration system then retrieves the object from the repository in a step 72 and verifies that the retrieved associated object has not been corrupted (step 68).

After the registration system has checked the object, it creates an initial Receipt In Progress (RIP) record and sends it to the tracking system (step 74). The tracking system verifies that the account number presented in the record is valid and that sufficient funds exist in the account to process the application (step 76).

The application and the associated object can now be accessed by the rights examiner, by running an examiner's user interface program on the examiner's workstation (step 78). Once the examiner approves the application, the registration system assigns a registration number, and the system creates the rights registration certificate (step 80). A copy of the certificate is mailed electronically to the rights registrant. An updated RIP record which shows the registration application's final status is subsequently sent to the tracking system (step 82).

Registering an Object not in a Repository

The detailed steps for registering without first depositing a copy in a repository are shown in FIGS. 10 through 13.

First, the user 42 (the rights applicant) generates a digital signature for the object (step 250) using a private key and makes the object 43 (in one file), digital signature 45 (in a second file), and public key certificate chain 47 (in a third file) available to the UA system 34 (step 252). The UA user supplies rights registration application information 49 by filling out a form on th screen. If the user does not fill in the publication date field, then the object is considered unpublished by the rights registrar. If the field is filled in, then the object is treated like a published work. The UA user digitally signs the rights application information in a step 254.

The UA then sends a PEM/MIME message 202 to the registration system 40. (MIME is a multimedia electronic mail specification to allow for multimedia objects to be handled.) The message contains the object, the user's digital signature 45 over the object, the public key certificate chain 47 for the user, the rights registration application 49 information, a digital signature (not shown) over the rights registration application information, and the UA user's public key certificate chain (not shown) (step 256). The entire message is signed by the UA user.

The registration system 40 receives the PEM/MIME message. An entry recording the receipt of the message is placed into a log file in a step 258.

The registration system verifies that it accepts rights applications from the distinguished name of the UA user (step 260). If not, it returns a message to the UA user, and the verification failure is recorded in the log file (step 262).

The registration system attempts to validate the digital signature over the entire message in step 264. If validation fails (i.e., the decrypted hash value does not match the computed message hash or one of the certificates in the public key certificate chain has been revoked), a message is returned to the UA user. The validation failure is recorded in the log file (step 262). If the validation succeeds, then an application received message is sent to the UA user (step 266).

The registration system attempts to validate the rights registration information (only simple checks are performed) in step 268. If validation fails, a message is returned to the UA user. The validation failure is recorded in the log file (step 262).

If the object was included in the PEM/MIME message (step 270), the registration system attempts to validate the digital signature over the object (step 272). If validation fails, a message is returned to the UA user. The validation failure is recorded in the log file (step 262).

If the validations of the application information and the object (if it was included in the PEM/MIME message) were successful, then the following are entered in step 274 into the registration system's work in progress database: the application information; the digital signatures; the public key certificate chains; and the object (if available). The entry into the work in progress database is recorded in the log file.

If the PEM/MIME message did not include the object (step 276), the registration system attempts to retrieve a copy of it in step 278. If the attempt fails, a message is sent to the UA user (step 280). The application information, digital signatures, and public key certificates are removed from the work in progress database. Entries are made in the log file recording the retrieval failure and the removal of the information from the work in progress database in step 282.

If the retrieval attempt succeeds, then the registration system attempts to validate the digital signature over the object in step 284. If validation fails, a message is sent to the UA user (step 280). The application information, digital signatures, and public key certificates are removed from the work in progress database. Entries are made in the log file recording the validation failure and the removals from the work in progress database (step 282).

If the object has been published (the rights user filled in the published date field) (step 286), then the object is placed in the acquisition queue in step 288.

The registration system now prepares an initial Receipt In Progress (RIP) record (step 290). The registration system converts the information located in the title and claimant name fields in the registration request into the title and claimant name fields in the RIP record. The following conversions are performed: title words that are located in a stop word list are deleted and title words that are located in an abbreviated terms list are abbreviated.

A bar-code number (or other identifier) is assigned to the registration request (step 290). A verify and debit request, which contains the bar-code number (and other RIP record information) is formatted and sent to the tracking system via the File Transfer Protocol (FTP) in step 292.

The tracking system verifies the account (step 294) and debits the requested amount from the account. If the account is not valid, the tracking system will send an invalid account number presented message to the registration system (step 296). If the account is valid, but insufficient funds exist for this transaction (step 298), then the tracking system will send an insufficient funds message to the registration system (step 296). In either error case, the validation failure is recorded in the registration system's log file; and the rights registration application is removed from the works in progress database (step 282). If the object was unpublished, it is deleted from the registration system in step 300. If a published object and registration request is resubmitted, it is possible that a object might be placed in the acquisition queue multiple times. Manual procedures catch the duplicate entries.

If the tracking system 46 (FIG. 10) successfully performed the account verification and debit processing, it sends an account is OK message to the registration system in step 302. the tracking system prepares an initial RIP record and places it in it's database. If the object was unpublished, a copy of it is placed into the acquisition queue.

The registration system moves the registration request to the examiner queue database in step 304. The registrar user's workstation 50 (FIG. 10) now has access to the registration request. The examiner uses workstation 50 to view the object on the screen, to add his name to the examined by line on the application form and to record the class designation for the rights registration (step 306). The converted form of the author and title (as stored in the RIP record) are also shown to the examiner.

If the examiner approves the application (step 308), an examination-is-approved message is sent from the workstation to the registration system in a step 310. The registration system assigns a registration number (step 312), and the system creates and digitally signs the rights registration certificate, which includes the registration number and the date on which registration was granted (step 314). The rights registration certificate is sent in a PEM message to the UA user in a step 314. The certificate may be sent directly to the UA or indirectly via the repository. The certificate is archived on the registration system (step 312). The certificate also could be stored on a system that retains the scanned images of the manually created certificates.

If the examination results in the rights registration application being rejected, the examiner uses the workstation to send a rights registration rejection PEM message via the UA to the applicant explaining the rejection (step 318).

If the registration was approved or denied, an updated RIP record is forwarded to the tracking system in a step 320. Once the tracking system has added the record to its database, it sends a RIP-record-update-OK message to the registration system (step 322).

In step 324, the registration system moves the registration request to the cataloging system. The cataloger's workstation 57 (FIG. 10) now has access to this registration request.

Using a connection to the cataloging system, the cataloger creates the cataloging information in step 326. When the task is finished, the workstation sends a finished catalog message to the registration system (step 328). The registration system places a registration-application-processing-complete message in the log file (step 330).

Placing an Object into a Repository

Alternatively, the rights holder may choose first to place an object into a repository, as shown in FIGS. 14 through 17.

In a first step 350, the user 42 makes the object (object) available to the UA 34. The UA then sends a request for a handle to a handle generator system 36 (step 352).

The handle generator system sends a handle to the UA system (udp) in step 354.

The UA sends a PEM message to the rights management system 38 containing the handle, any non-simple terms and conditions for obtaining a copy of the object (which must include free access to the object for the registrar), and the list of distinguished names of those who are allowed to make changes to the information (stored in the RMS) which is associated with the handle (step 356). The PEM message is signed by the UA user.

The RMS verifies that it accepts new submissions from the distinguished name of the UA user in step 358. If not, the RMS sends an invalid-distinguished-name PEM message to the UA user and discards the contents of the received message (step 360).

The RMS validates the digital signature on the received PEM message (step 362). If the validation fails, the RMS sends an invalid-digital-signature PEM to the UA user and discards the contents of the received message (step 360).

The RMS verifies that it does not already have a set of terms and conditions stored for the handle (step 364). If it does, it sends a terms-and-conditions-already-registered PEM to the UA user and discards the contents of the received message (step 360).

The RMS stores the handle and the associated terms and conditions (step 366) and sends a confirming PEM to the UA user (step 368).

In a step 370, the UA system computes the digital signature over: the object's handle; a date/time group-(the nominal date/time of submission of the object to the repository); and the object.

The UA system sends a PEM/MIME message to the repository 36 (FIG. 14) containing the object's handle, the submission date/time group, the object (or the information needed to retrieve a copy of the object), the UA user's digital signature over the above, the UA user's public key certificate chain, the simple terms and conditions for the object, if any, and the distinguished name or names of the RMS(s) holding the non-simple terms and conditions for the object, if applicable. The entire message is signed by the UA user (step 372).

The repository verifies that it accepts object submissions from the distinguished name of the UA user in a step 374. If not, it sends an invalid-distinguished-name PEM message to the UA user and discards the received message (step 376).

The repository validates the digital signature over the entire message in step 378. If the validation fails, the repository sends an invalid-digital-signature PEM message to the UA user and discards the received message (step 376).

If the object was not included in the received PEM/MIME message (step 380), the repository attempts to retrieve a copy of the object (e.g., via anonymous FTP) in a step 382. If retrieval fails, the repository sends an object-retrieval-failed PEM message to the UA user and discards the received message (step 376).

The repository validates the UA user's digital signature over the handle, nominal submission date/time group, the object (step 384), and the reasonableness of the submission date/time group (not in the future, not too far in the past) (step 386). If either of these validations fail, the repository sends an invalid-submission PEM to the UA user and discards the received message (step 376).

In step 388, the repository stores the object's handle, the submission date/time group, the object, the UA user's digital signature over the above, the UA user's public key certificate chain, the simple terms and conditions for the object, if any, the distinguished name of RMS, if applicable, and other properties. The repository then computes its own digital signature over the handle, the submission date/time group from the received message and the object (step 390). In step 392, the repository sends a PEM to the UA user containing the handle, the repository's digital signature, and the repository's public key certificate chain.

In step 394, the UA system verifies the repository's digital signature over the handle, date/time group, and object. The UA system then stores the handle, the nominal submission date/time group, the object, the repository's digital signature, and the repository's public key certificate chain (step 396).

The UA system computes the hash of the object's handle using the handle system hashing function (step 398). The UA system then looks up the domain name of the handle server 38 responsible for the handle in its cached copy of the hash value/handle server table (step 400).

In step 402, the UA system sends a PEM to the handle server containing the handle, and one or more pairs of domain name of repository and domain name of the RMS, and a list of distinguished names of persons who are permitted to change the pairs of domain names associated with the handle. The message is signed by the UA user.

The handle server receives the PEM message and verifies that it is responsible for the handle in step 404. If not, it sends an invalid-handle-server-selected PEM to the UA user and discards the other information (step 406). If th UA system receives an invalid-handle-server-selected rejection message from the handle server, it downloads a new copy of the hash value/handle server table from the handle server directory 59 (FIG. 15) (step 408) and repeats steps 398 through 404.

If the handle server is responsible for the handle submitted by the UA system, it validates the digital signature over the PEM message in step 410. If the validation fails, the handle server sends an invalid-digital-signature PEM message to the UA user and discards the other information (step 412).

The handle server verifies that it accepts submissions from the distinguished name of the UA user in step 414. If not, the handle server sends an invalid-distinguished-name PEM message to the UA user and discards the other information (step 412).

The handle server verifies the syntax of the pairs of domain names submitted with the handle in step 416. If it detects any errors, it sends an invalid-handle-submission-record syntax PEM message to the UA user and discards the other information (step 412).

The handle server stores the handle, the pairs of domain names, and the list of distinguished names (step 418) and sends a PEM acceptance message to the UA user (step 420).

Registering an Object Already in a Repository

After the object has been deposited, an application to register may be submitted (FIGS. 18 through 22).

The user (the rights applicant) 42 first generates a digital signature for the object (step 450) and makes the digital signature (in a file), and public key certificate chain (in a second file) available to the UA system 34 (step 452).

The UA user supplies the rights registration application information by filling out a form on the screen in step 454. This includes the handle 203 for the object already stored in a repository. Any object stored in a repository is considered published by the rights registrar. Therefore, the publication date field must be entered in the application form. The UA user digitally signs the rights application information.

In step 456, the UA system sends a PEM/MIME message to the registration system 40 containing the object's handle, the user's digital signature over the object, the public key certificate chain for the user, the rights registration application information, the digital signature over the rights registration application information, and the UA user's public key certificate chain. The entire message is signed by the UA user.

The registration system receives the PEM message. An entry recording the receipt of the message is placed into a log file in step 458. The registration system then verifies that it accepts rights applications from the distinguished name of the UA user (step 460). If not, it returns an unknown-account PEM to the UA user, and the verification failure is recorded in the log file (step 462).

The registration system attempts to validate the digital signature over the entire message in step 464. If validation fails (i.e., the decrypted hash value does not match the computed message hash or one of the certificates in the public key certificate chain has been revoked), a received-corrupted-application PEM is returned to the UA user. The validation failure is recorded in the log file in step 462.

If the validation succeeds, then an application-received PEM is sent to the UA user in step 466.

The registration system attempts to validate the rights registration information (only simple checks are performed) in step 468. If validation fails, a rights-application-is-formatted-incorrectly PEM is returned to the UA user. The validation failure is recorded in the log file (step 462).

If the validation of the application information was successful, then the following are entered into the registration system's work in progress database: the application information, the digital signatures, and the public key certificate chains. The entry into the work in progress database is recorded in the log file in step 470.

The registration system hashes the object's handle in step 472. It uses this hash to perform a table lookup in the hash code/handle server table (step 474), which was previously obtained from the handle server directory. The registration system then sends a request-for-pointer-information UDP packet to a handle server 58 (FIG. 18) in step 476.

In step 478, the handle server verifies that the handle falls within the set of handles for which hash values it is responsible. If it is not in this set, the handle server sends an invalid-handle-server-selected response UDP packet to the registration system (step 480).

If the registration system receives an invalid-handle-server-selected response UDP packet, it refreshes its hash code/handle server table from the handle server directory (step 482), and the registration system repeats steps 472 and 474.

If the handle server is responsible for the handle, it verifies that the handle is present in its database in step 484. If not, it sends a handle-not-found response UDP packet to the registration system (step 486).

If the registration system receives a handle-not-found response UDP packet, it returns a requested-object-is-unavailable PEM message to the UA user (step 488), and the handle lookup failure is recorded in the log file. The registration system removes the entry for the registration request from the work in progress database in step 490.

If the handle server has the handle in its database, it returns the pointers associated with the handle in a UDP packet to the registration system in step 492.

For each pointer returned by the handle server, the registration-system tries to obtain a copy of the object. If a copy is successfully obtained from one repository 36 (FIG. 18), then the rest of the pointers are ignored. If the registration system cannot obtain the object from any of the repositories, the registration system returns an unable-to-obtain-a-copy-of-the-object PEM to the UA user (step 494). The failure to retrieve the object is recorded in the registration system's log file, and the rights registration entry is removed from the work in progress database (step 496).

If a pointer does not indicate that RMS 38 (FIG. 18.) negotiation is required, the registration system ignores the object pointer. If a pointer does indicate that RMS negotiation is required (step 498), the registration system attempts to obtain the object via the RMS. First, in step 500, the registration system connects to the RMS.

The RMS returns a random-value tag to the registration system in step 502. In step 504, the registration system sends the following information to the RMS: the object's handle, the registrar's digital signature over the RMS generated random-value tag, the registrar's public key certificate chain, the domain name and the port number which will be used by the registration system to receive the object.

The RMS validates the digital signature over the random-value tag in step 506. If the signature is not correct, the RMS sends an invalid-random-value-tag response to the registration system in step 494. The registration system logs this error and removes the rights registration information from the work in progress database (step 496).

The RMS verifies in step 508 that the registration system meets the terms and conditions for the object. If the registration system does not meet the terms and conditions, a requester-unauthorized-rejection response is returned to the registration system (step 494). The registration system logs this error and removes the rights registration information from the work-in-progress database (step 496).

The RMS connects to the repository in step 510, and the repository returns a random-value tag to the RMS (step 512).

The RMS sends the following information to the repository in step 514: the object's handle; the RMS digital signature over the repository generated random-value tag; the RMS public key certificate chain; and the domain name and the port number which are used by the registration system to receive the object.

The repository verifies the digital signature of the RMS over the random-value tag in step 516. If the signature is not correct, the repository sends an invalid-random-value-tag response to the RMS (step 518). The RMS logs the error and sends a remote-RMS-error-invalid-random-value-tag error to the registration system in step 520. The registration system then logs this error and removes the rights registration information from the work in progress database (step 522).

In step 524, the repository verifies that the RMS is allowed to request object transfers for the object. If the transfer is not allowed, the repository sends an invalid-RMS response to the RMS (step 518), which forwards the response to the registration system (step 520). The registration system logs the error in its log file, and the rights registration information is removed from the work in progress database (step 522).

The repository sends a object-retrieval-is-allowed response to the RMS (step 526), and the repository disconnects from the RMS (step 528).

The RMS forwards the object-retrieval-is-allowed response to the registration system (step 530), and the RMS disconnects from the registration system (step 532).

The repository connects to the address/port specified in the original request, and it transmits to the registration system the object's handle and the object, signed by the repository in step 534. The repository then sends a object-has-been-delivered confirmation to the RMS (step 536).

The registration system validates the user's digital signature over the object in step 538. If validation fails, an invalid-object-digital-signature-presented PEM message is returned to the UA user in step 540. In step 542, the validation failure is recorded in the log file, and the rights registration is removed from the works in progress database.

Steps 286 et seq. (FIG. 11) are then followed.

The registration system prepares an initial receipt in progress (RIP) record (step 290). The registration system converts the information located in the title and claimant name fields in the registration request into the title and claimant name fields in the RIP record. The following conversions are performed: title words that are located in a stop word list are deleted and title words that are located in an abbreviated terms list are abbreviated.

The object is placed into the work in progress database. A bar-code number is assigned to the registration request (step 290). A verify-and-debit request, which contains the bar-code number (and other RIP record information) is formatted and sent to the tracking system in step 292.

The tracking system verifies the account and debits the requested amount from the account in step 294. If the account is not valid, the tracking system will send an invalid-account-number presented message to the registration system (step 296). If the account is valid, but insufficient funds exist for this transaction (step 298), then the tracking system will send an insufficient-funds message to the registration system (step 296). In either error case, the validation failure is recorded in the registration system's log file; the rights registration is removed from the works in progress database (step 282).

If the tracking system successfully performed the account verification and debit processing, it sends a account-is-OK message to the registration system in step 302. the tracking system prepares an initial RIP record and places it in its database.

The registration system then moves the registration request to the examiner queue database in step 304. The examiner's workstation now has access to this registration request. The examiner uses the workstation 50 (FIG. 18) to view the object on the screen, to add his name to the examined by line on the application form and to record the class designation for the rights registration (step 306). The converted form of the author and title (as stored in the RIP record) are also shown to the examiner.

If the-examiner approves the application in step 308, an examination-is-approved message is sent from the workstation to the registration system (step 310). The registration system assigns a registration number (step 312), and the system creates and digitally signs the rights registration certificate, which includes the registration number and the date on which registration was granted (step 314). The rights registration certificate” is sent in a PEM message to the UA user in step 316. The certificate is archived on the registration system.

If the examination results in the rights registration application being rejected, the examiner uses the workstation to send a rights-registration-rejection PEM message to the applicant explaining the rejection (step 318).

If the registration was approved or denied, an updated RIP record is forwarded to the tracking system in step 320. Once the tracking system has added the record to its database, it sends a RIP-record-update-OK message to the registration system (step 322).

The registration system moves the registration request to the catalog queue database in step 324. The cataloger's workstation 57 (FIG. 19) now has access to this registration request. Using a telnet window connected to the cataloging system, the cataloger creates the cataloging information (step 326). When he is finished, the workstation sends a finished catalog message to the registration system in a step 328. In step 330, the registration system places a registration-application-processing-complete message in the log file.

Once the registrar has completed its work, the object itself may be purged from the files of the registrar because the digital signature and the existence of the full object at a repository are sufficient to assure that a valid copy of the object may be obtained at any time. This significantly reduces the storage requirements at the registrar.

Software Organization

The following software packages run on workstation 42:

| | |
|---|---|
| MH w/PEM and MIME | MH is a full featured user agent for |
| extensions | handling Internet mail. Rather then |
| | being a single comprehensive program, |
| | MH consists of a collection of fairly |
| | simple single-purpose programs to |
| | send, receive, save, and retrieve |
| | messages. MH is extensible, other |
| | user agents may be layered on top of |
| | the MH executables. The MIME |
| | extensions provide multiple part |
| | multiple body type message |
| | capabilities (e.g., for multimedia |
| | mail). |
| PEM administrative | These tools are used to generate |
| tools | private and public keys and user |
| | certificates. |

The following executables run on the rights user's workstation 42:

| | |
|---|---|
| submit_registration | This tool is used to create and |
| | submit a rights registration |
| | application. |
| install_ipms | This tool will install the MH/PEM |
| | and submit_registration tools on the |
| | rights user's workstation. |

The registration and recordation system (RRS) must perform the following activities: the RRS must provide the user interface (as an X-windows client) for rights office personnel to view, edit, approve, reject or defer rights registration applications; the RRS must provide the user interface (as an X-windows client) for rights office personnel to view digital objects; the RRS must support electronic mail transmission and reception; the RRS must maintain several queues of the rights registration application as it passes through the various states of reception, examining and approval/disapproval; until the repository is completed, the RRS must save all of the digital objects received (as a temporary repository; until another storage is facility is created/found, the RRS must retain all of the registration certificates that have been generated.

The following software packages run on the UA host:

| | |
|---|---|
| MH w/PEM and MIME | MH is a full featured user agent for |
| extensions | handling internet mail. Rather th n |
| | being a single comprehensive program, |
| | MH consists of a collection of fairly |
| | simple single-purpose programs to |
| | send, receive, save, and retrieve |
| | messages. MH is extensible, other user |
| | agents may be layered on top of the MH |
| | executables. |
| PEM administrative | These tools are used to generate |
| tools | private and public keys and user |
| | certificates. |

The following executables run on the rights user's workstation:

| Program/Daemon | Performs |
|---|---|
| receive_application | When sendmail receives a message |
| | addressed to |
| | “submit_registration”, it will |
| | pass the message to |
| | receive_application, which will |
| | perform the initial |
| | verifications on the message. |
| retrieve_object | If the object was not included |
| | in the original message, this |
| | program attempts to retrieve the |
| | object. This program is executed |
| | periodically by cron. This |
| | program is also responsible for |
| | performing time-out functions |
| | (for retrieving the object). |
| prepare_init_RIP_record | This program, which is started |
| | by r c ive_application or |
| | retrieve_object is used to |
| | create and queue the initial RIP |
| | record, which will be sent to |
| | the tracking system. |
| xmit_files_to_the | This program, started by cron, |
| tracking system | is used to send already |
| | formatted files to the tracking |
| | system. |
| get_files_from_the | This program, started by cron, |
| tracking system | is used to retrieve response |
| | files from the tracking system. |
| process_init_RIP_response | If get_files_from_the tracking |
| | system receives an initial RIP |
| | record response, it invokes this |
| | program to handle the response |
| | from the tracking system. |
| view_application | This user application is invoked |
| | by the Examiner to view, edit, |
| | accept or reject the rights |
| | application. This program also |
| | displays the digital objects to |
| | the Examiner. The Cataloger may |
| | also use this program to view |
| | the application and associated |
| | digital object. |
| application_queue_server | This is the “back-end” process |
| | that manages application/object |
| | requests received from user |
| | programs (i.e. |
| | view_application.) |
| send_resp_to_applicant | This program, which is invoked |
| | by view_application, is used to |
| | send the application approval |
| | and certificate or the |
| | application rejection to the |
| | rights applicant. |
| update_RIP_record | This program, which is invoked |
| | by view_application, is used to |
| | create an updated RIP record, |
| | which will be transmitted to the |
| | tracking system, using |
| | xmit_files_to_the tracking |
| | system. |
| process_update_RIP_resp | If get_files_from_the tracking |
| | system receives an updated RIP |
| | record response, it invokes this |
| | program to handle the response |
| | from the tracking system. |
| install_rrs | This program is used to install |
| | the additional configuration |
| | files and software required for |
| | the RRS system. |

retrieve_object
prepare_init_RIP_record
xmit_files_to_the tracking system
get_files_from_the tracking system
proc ss_init_RIP_response
view_application
application_queue_server
send_resp_to_applicant
update_RIP_record
process_update_RIP_resp
install_rrs

Obtaining a Digital Object from a Repository

This section describes how a user may obtain an account and retrieve digital objects from repositories.

Before a user can retrieve any objects for which payment is required, the user must first establish an account with a payment server system 702 on the network (FIG. 25). This system will be used to create new accounts, debit and credit user accounts, and interface with one or more credit service centers 704. Payment servers have the following attributes:

Payment servers must be qualified; it must be possible to verify that a payment server is valid.

This may be accomplished by establishing payment server distinguished names; if a signed message is received from a server with a payment server distinguished name, then the payment server is valid.

Payment servers may charge users for establishing accounts.

Users may request server information (including establishing account charges) from a server before attempting to set up a new account.

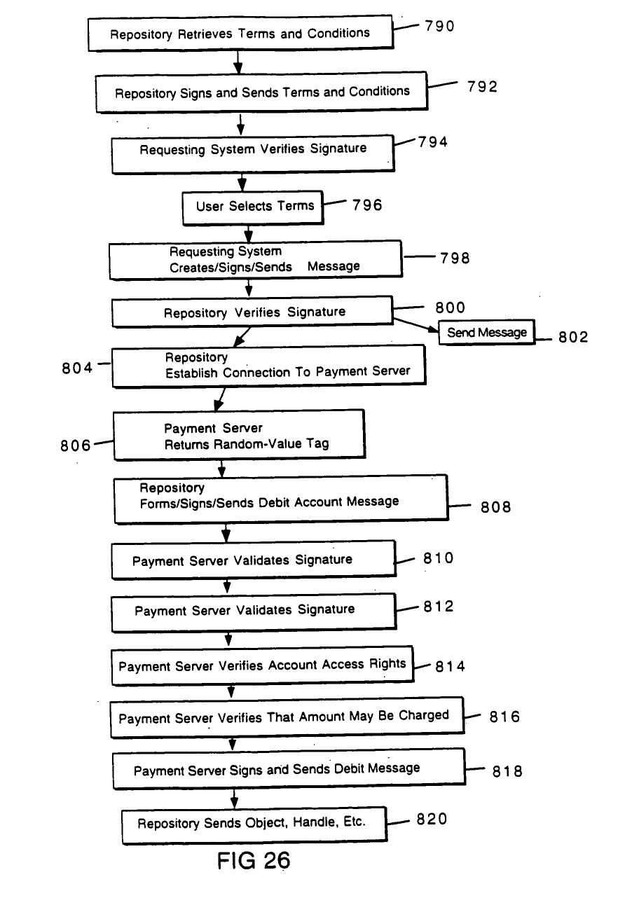

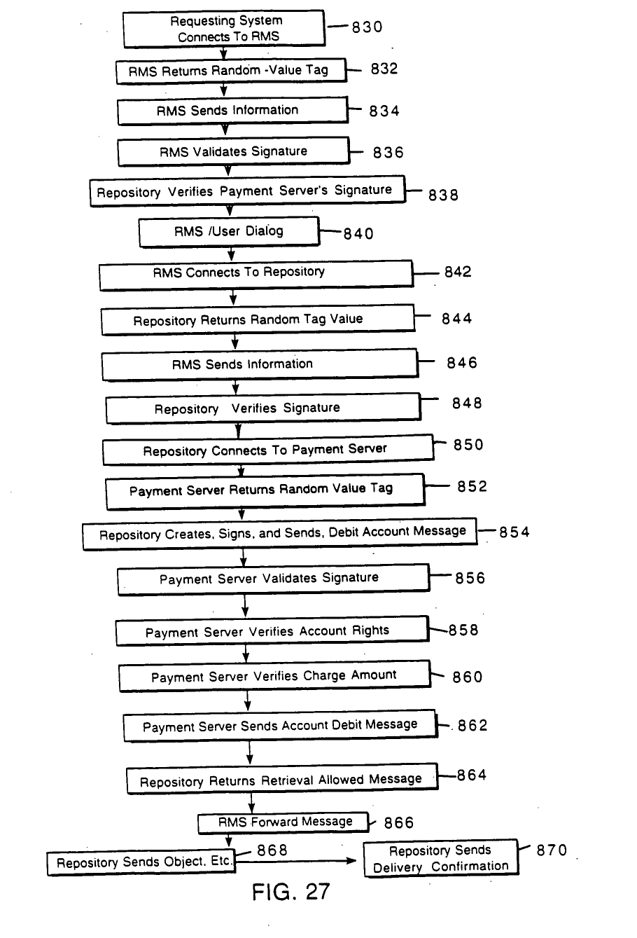

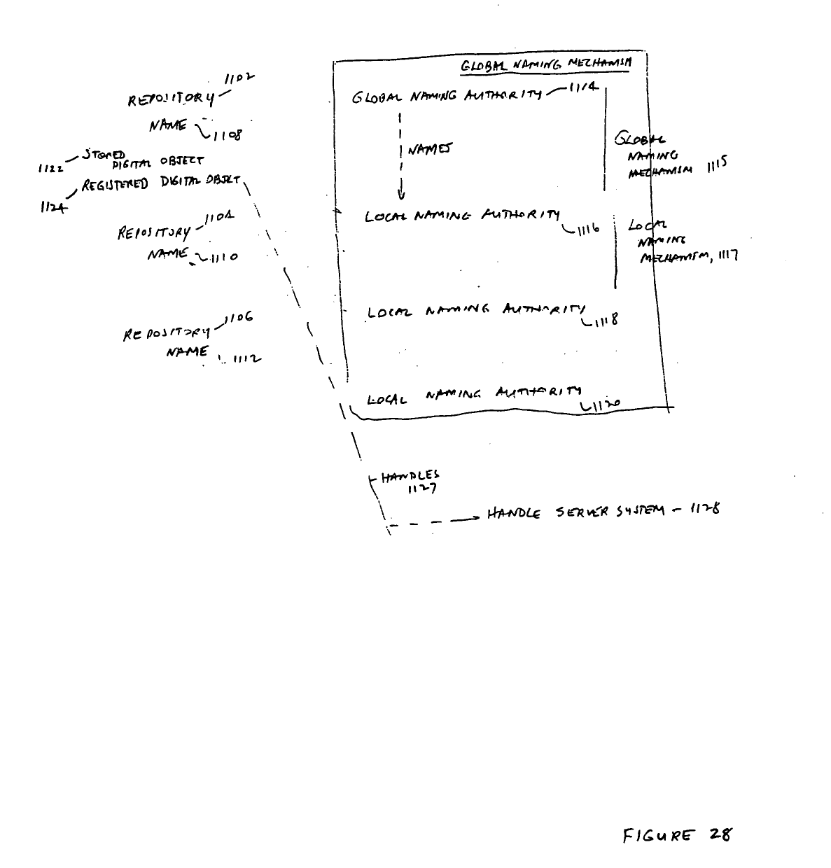

The following steps (FIG. 26) illustrate how a user can establish a new account with a payment server. A user must have a certificate and a valid credit card number in order to establish an account.

The user (or his software agent) formats (706) a setup-new-account message containing the following:

The user's credit card number or other credit information;

Other identifying information, such as a street address, phone number;

Requested credit amount;

A list of valid signatures (either public key certificates and their associated certificate chains or distinguished names) for people allowed to charge to the account.

Optional category of use (e.g. this account is used to retrieve video objects only.)

Optional time limit (e.g. this account will be valid until Dec. 31, 1995.) The payment server will normally keep an account active as long as a minimum line of credit is available.

The setup-new-account message is digitally signed by the person establishing the account, and the signed message is sent (708) to the payment server with the above information.

The payment server verifies the signature on the received message (710). If the signature is invalid, the payment server sends an invalid-signature message to the user's system (712). Optionally, it may identify a maximum allowed credit limit.

If the signature is valid, using standard electronic credit card checking protocols or other methods as appropriate, the payment server electronically verifies the credit card number or other credit information, and requested credit line with a credit card service center or other credit authority (714).

If the credit card number or other credit information is not valid (718), the payment server will send an invalid-credit-card message to the user's system (720).

If the requested credit limit is too high, the payment server will send a requested-credit-limit-is-too-high message to the user's system.

The payment server will verify that the other authorized user's identities are valid (722). If any are invalid, an invalid-authorized-user-specified message is sent (724) to the user's system.

The payment server assigns an account number to the user (726) and stores the account information in a database for later use.

The payment server formats a new-account-response message (728) containing the following:

Account Number

Credit Limit Amount

Time Limit

Categories of Use

List of authorized users (public key certificates plus the certificate chains.)

The requesting system or user's public key certificate chain, which will be used to verify the requestor's identity. Other less efficient methods can also be used, e.g. the payment server could be given sufficient information (the distinguished name) about the user to obtain the certificate chain from another database.

The payment server signs the formatted message and sends it to the user's system. Optionally, the user may be charged a fee for establishing this account and for maintaining it.

The user's system encrypts and stores (730) the received signed message. This account data will be submitted with any activity that may be billed.

Retrieving from a Repository (Simple Terms and Conditions)

Once an account is established, the user may retrieve an object from the repository by the following steps (FIGS. 25 and 27).

The system requesting the digital object obtains (740) the hash code/handle server table from the handle server directory 59. This is done during the system's initialization.

A user (or more likely, his software agent) obtains a handle 743 for an object (742). The handle may be obtained as part of a result of a bibliographic search or be provided by some other electronic means such as an electronic reference list in another object, or by scanning a barcoded sequence on paper.

The system that is retrieving the digital object is referred to as the requesting system 745.

Once the handle is obtained, the system that retrieves the object “hashes” the object's handle and uses this hashed value to perform a table lookup in the hash code/handle server table 744.

The requesting system sends a request-for-pointer-information UDP packet 748 to the handle server.

One or more pointers, once returned, identifies the network location of the one or more repositories (if one is associated with the object) and one or more rights management system, if one is associated with the object. This strategy assures a random distribution of handle server requests among many handle servers distributed on a network without a central nodal point in the system (for reliability). The handle server verifies that the handle falls within the set of handles for whose hash values it is responsible 750.

If it is not in this set, due to some dynamic system change or error condition, the handle server sends an invalid-handle-server-selected response UDP packet to the requester 752.

If the requesting system receives an invalid-handle-server-selected response UDP packet, it refreshes its hash code/handle server table from the handle server directory, and the requesting system repeats prior steps. This will typically be needed only if the table has changed between the time the table was downloaded and the actual request was made.

If the handle server is responsible for the handle, it verifies that the handle is present in its database 756. If not, it sends a handle-not-found response UDP packet to the requesting system 758.

If the requesting system receives a handle-not-found response UDP packet, it informs (760) the user that it is unable to retrieve the object.

An object may be stored in several repositories.

Multiple pointers to these repositories may be returned to the requesting system. For each pointer returned by the handle server, the requesting system uses the pointer to attempt to obtain a copy of the digital object 762. If a copy is successfully obtained from one repository, the rest of the pointers will generally be ignored. If the requesting system cannot obtain the object from any of the repositories, it informs the user that it is unable to retrieve the object 764.

For retrieval purposes, the requesting system establishes a connection to the repository 766, which takes the form of a small set of transactions. The repository may examine the calling network address or the requesting system in order to determine if the repository is being inundated with requests from one system. If the repository determines that it is being bombarded, the repository may disconnect from the requesting system and refuse to accept additional requests for a period of time 768.

Normally, however, the repository returns a random-value tag to the requesting system 770. A flag indicating if payment is required to obtain “Terms and Conditions” is included.

The requesting system needs the object's “Terms and Conditions” before the object can be retrieved. The requesting system signs and sends the following request-terms-and-conditions message 772 to the repository:

the object's handle;

the requesting system or user's digital signature over the repository generated random-value tag;

the requesting system or user's public key certificate chain, which will be used to verify the requestor's identity. Other less efficient methods can also be used, e.g. the repository could be given sufficient information (the distinguished name) about the user to obtain the certificate chain from another database.

This is needed in the event the repository needs to bill for providing the Terms and Conditions;

a unique tag, assigned by the requesting system;

account information, previously signed by the payment server.

The repository verifies the digital signature of the requester over the repository generated random-value tag 774. If the signature is not correct, the repository sends an invalid-random-value-tag response to the requesting system. The requesting system should log this error.

The repository verifies the payment server's signature over the account information 778. If the signature is not correct, the repository sends an invalid-account-information response to the requesting system. The requesting system should log this error.

The repository retrieves the Terms and Conditions associated with the specified handle 790. If no object is associated with the handle, the repository sends an object-not-found message to the requesting system. The requesting system should log this error.

Otherwise, the repository signs the “Terms and Condition” message and sends 792 it to the requesting system, including:

The objectized list of terms/conditions/rights, along with the charge associated with each object and a status flag showing if the term/condition/right is mandatory;

The user-assigned unique key, which was received in the request-terms-and-conditions message;

Either the original random-value tag or possible a new random-value tag, generated by the repository. This is to avoid play back protection in the event the object identified by the handle is retrieved later.

The requesting system verifies the repository's signature over the received “Terms and Conditions” message 794. If the signature is invalid, the error is logged.

The user selects the terms and conditions desired 796, including the number of terms (e.g., A user may buy the right to make 5 copies of the object or to perform it ten times). The requesting system uses this information to create the retrieve-object message, including:

the object's handle 798;

the repository generated random value tag;

a list of the accepted “Terms and Conditions”, including the quantity of each, where applicable;

the user's account information, which was originally signed by the payment server;

the requesting system or user's public key certificate chain, which will be used to verify the requestor's identity. Other less efficient methods can also be used, e.g. the repository could be given sufficient information (the distinguished name) about the user to obtain the certificate chain from another database. the domain name and the port number which are used by the requesting system to receive the object.

limitations, if any, on the object by the requesting system (e.g. maximum object size it can receive)

The entire message is signed by the requester. This is similar to signing a credit card slip.

The repository verifies the digital signature of the requestor over the random-value tag 800. If the signature is not correct, the repository sends an invalid-random-value-tag response to the requesting system 802. The requesting system should log this error.

The repository establishes a connection to the payment server, 804.

The payment server returns a random-value tag to the repository 806.

The repository formats a debit-account message 808, including:

The retrieve-object message, as received by the repository and signed by the requester;

The random value tag received from the payment server;

The repository's public key certificate chain, which will be used to verify the repository's identity. Other less efficient methods can also be used, e.g. the payment server could be given sufficient information (the distinguished name) about the user to obtain the certificate chain from another database.

The repository signs the retrieve-object and random-value portion of the message. The repository sends the debit-account message to the payment server system.

The payment server system validates the repository's signature over the debit-account message 810. If the signature is invalid, the payment server logs the error and sends a invalid-vendor-signature message to the repository.

The payment server system then validates the requestor's signature over the contained retrieve-object message 812. If the signature is invalid, an invalid-requestor-signature message is sent to the repository.

The payment server validates the account information sent to it and verifies that the account is valid.

If the requester is not a valid user of the account, a invalid-user-for-account message is sent to the repository, and the payment server logs the event. Otherwise, the payment server, using already existing electronic credit verification methods, verifies that the amount may be charged to the account 816.

If the credit check is not successful, the appropriate error message (e.g. “Credit Line is insufficient”, “Credit Card has Expired”) is logged and sent to the repository.

Otherwise an account-has-been-debited message is signed by the payment server and sent to the repository 818.

The repository connects to the address/port specified in the request, and it transmits 820 to the requesting system:

the object's handle;

the total amount debited from the account;

the object, signed by the repository;

portions of the relevant terms and conditions, if appropriate.

Retrieving Under Non-Simple Terms and Conditions

The following steps are followed for retrieving an object under non-simple terms and conditions.

If the user does not know the current terms and conditions associated with the object, steps 740 through 794 (FIGS. 27 and 28) are first performed. If the user determines that the terms and conditions returned by the repository are not appropriate by themselves, then additional negotiations with the RMS associated with the digital object are required.

If a user already knows that negotiations are required with an RMS, but the RMS associated with the digital object is not yet known, then the user's system must perform steps 740 through 764 (FIG. 27).

Otherwise, referring to FIG. 29, the requesting system establishes a connection to the RMS 830.

The RMS returns a random-value tag to the requesting system 832.

The requesting system sends the following information to the RMS:

the object's handle;

the requestor's digital signature over the RMS generated random-value tag;

the requestor's public key certificate chain;

the domain name and the port number which will be used by the requesting system to receive the object;

a random value tag, assigned by the requesting system;

the accounting data previously signed by the payment server.

The RMS validates the digital signature over the signed random-value tag 836. If the signature is not correct, the RMS sends an invalid-random-value-tag response to the requesting system. The requesting system logs this error.

The repository verifies the payment server's signature over the account information 838. If the signature is not correct, the repository sends an invalid-account-information response to the requesting system. The requesting system should log this error.

The RMS enters into a mixed initiative dialog 840 with the user to determine what terms and conditions are mutually acceptable, if any. This may also entail human interaction.

The RMS connects to the repository 842, and the repository returns a random-value tag to the RMS 844.

The RMS sends 846 the following information to the repository:

the object's handle;

the RMS's digital signature over the repository generated random-value tag;

the RMS public key certificate chain;

the domain name and the port number which are used by the requesting system to receive the object;

the account information, previously signed by the payment server.

The repository verifies the digital signature of the RMS over the random-value tag 848. If the signature is not correct, the repository sends an invalid-random-value-tag response to the RMS. The RMS logs the error and sends a remote-RMS-error-invalid-random-value-tag error to the requesting system. The requesting system logs this error.

The repository verifies that the RMS is allowed to request object transfers for the object. If the transfer is not allowed, the repository sends an “invalid RMS” response to the RMS, which forwards the response to the requesting system. The requesting system logs the error in its log file. The repository establishes a connection to the payment server 850.

The payment server returns a random-value tag to the repository 852.

The repository formats a debit-account message 854, including:

The retrieve-object message, as received by the repository and signed by the requester;

The random value tag received from the payment server;

The repository's public key certificate chain, which will be used to verify the repository's identity. Other less efficient methods can also be used, e.g. the payment server could be given sufficient information (the distinguished name) about the user to obtain the certificate chain from another database.

The repository signs the retrieve-object and random-value portion of the message.

The repository sends the debit-Account message to the payment server system.

The payment server system validates the repository's signature over the debit-account message. If the signature is invalid, the payment server logs the error and sends a invalid-vendor-signature-message to the repository.

The payment server system then validates the requestor's signature over the contained retrieve-object message. If the signature is invalid, an invalid-requestor-signature message is sent to the repository.

The payment server validates the account information sent to it and verifies that the account is valid.

If the requester is not a valid user of the account, a invalid-user-for-account message is sent to the repository, and the payment server logs the event. Otherwise, the payment server, using already existing electronic credit verification, verifies that the amount may be charged to the credit card associated with the account 860.

If the credit check is not successful, the appropriate error message (e.g. “Credit Line is insufficient”, “Credit Card has Expired”) is logged and sent to the repository.

Otherwise an account-has-been-debited message is signed by the payment server and sent to the repository 862.

The repository sends 864 a object-retrieval-is-allowed response to the RMS, and the repository disconnects from the RMS.

The RMS forwards 866 the object-retrieval-is-allowed response to the requesting system, and the RMS disconnects from the system.

The repository connects to the address/port specified in the request, and it transmits to the requesting system 868:

the object's handle;

the total amount debited from the account;

the object, signed by the repository.

The repository sends a object-has-been-delivered confirmation to the RMS 870.

All of the transactions tracked and recorded in the above system could be used to feed an automated accounting system for a variety of purposes.

Retrieving Registration Information

The public access system will be based on a commercial DBMS. Queries to this system will be performed using standard database techniques via a direct connection or over a network.

Other embodiments are within the scope of the following claims.

What is claimed is:

1. A method of managing digital objects in a network, each of the digital objects comprising a set of sequences of digits and having an associated identifier which is unique across the network, the method comprising
storing the digital objects at locations accessible in the network using a storage technique which renders the digital objects secure against unauthorized access,
storing pointer information which associates each digital object identifier with a pointer indicating the location of the stored digital object in the network, and
for each of the digital objects, storing, separately from the digital object, validation information sufficient to permit a determination whether a purported instance of a digital object is identical to the original instance.

2. The method of claim 1 further comprising
permitting an authorized user to have access to the validation information, using the digital object identifier, to determine whether a purported instance of a digital object is identical to the original instance.

3. The method of claim 1 wherein the validation information comprises a digital signature over the digital object.

4. A method of managing reference information about digital objects in a network, each of the digital objects comprising a set of sequences of digits and having an associated identifier which is unique across the network, the method comprising
storing the digital objects,
storing reference information for each of the digital objects, and
storing validation information for each of the digital objects which is substantially smaller in size than the corresponding digital object and which enables a determination of whether a purported instance of a digital object is identical to the original instance.

5. The method of claim 4 further comprising
permitting authorized users to have access to the reference information using the unique identifier.

6. The method of claim 4 wherein the reference information comprises information concerning at least one of the following: registration of rights in digital objects; accesses to and uses of digital objects; the terms and conditions for access and use of digital objects; the ownership and licensing of rights to digital objects; links between different digital objects.

7. A method of storing digital objects in a network, each of the digital objects comprising a set of sequences of digits, the method comprising
generating an identifier for each of the digital objects which is unique across the network,
storing the digital objects in the network,
storing pointer information that associates each identifier of a digital object with the location of the digital object in the network,
generating verification information for each of the digital objects, the verification information being sufficient to determine whether a purported instance of the digital object is identical to the original instance, and
storing the verification information separately from the digital object.

8. The method of claim 7 wherein the pointer versus identifier information is stored in multiple servers on the network, and the identifiers are generated in a manner to distribute the pointer versus unique identifier information relatively evenly among the servers.

9. The method of claim 8 wherein the distribution of pointer versus unique identifiers to the multiple servers is based on a hashing algorithm.

10. A method for enabling users of a network to access digital objects stored in the network, each of the digital objects comprising a set of sequences of digits and having an associated identifier which is unique across the network, the method comprising
providing multiple pointer servers each of which accepts identifiers of a subset of the digital objects and returns corresponding pointers to the locations of the digital objects in the network, and
providing a directory server which accepts identifiers of any of the digital objects and returns the locations of the pointer servers which accept those identifiers.

11. A method of applying for registration of rights in digital objects comprising
storing the digital objects in a network,
generating validation information for each of the digital objects sufficient to determine whether a purported instance of a digital object is identical to the original,
generating a unique identifier for each of the digital objects,
associating with each of the unique identifiers a pointer to the location of the digital object in the network, and
submitting to a registering authority, an application for registration of rights including the validation information and the unique identifier.

12. A method of enabling holders of rights in digital objects to control terms and conditions under which they are accessed by users in a network, comprising
storing the digital objects in the network in a manner that permits only authorized access,
storing, in the network, information about terms and conditions for access to each digital object,
making the information about terms and conditions available to a user in connection with a request for access to a digital object,
enabling the user to indicate assent to the terms and conditions, and
permitting access to the user only upon the user indicating assent to the terms and conditions.

13. A method of enabling holders of rights in digital objects to control terms under which rights in the digital objects may be granted to others, comprising
storing, in the network, terms and conditions for licensing rights,
providing information on terms and conditions pertaining to works or other information or material that the digital object may be based on or incorporate,
making the terms and conditions available to potential rights holders and users, as appropriate, upon request via the network,
enabling the potential rights holder and the current rights holder to interact via the network to reach agreement on terms and conditions for grant of rights,
storing, in a recordation server on the network, information identifying grants of rights for digital objects on the network.

14. A method to permit a user to comply with terms and conditions of access to digital objects stored in a network, each of the digital objects comprising a set of sequences of digits and having an associated identifier which is unique across the network, the method comprising
storing in the network information which associates with each of the unique identifiers, a pointer to a rights management system including a terms and conditions server containing terms and conditions,
providing to the user in response to presentation of a unique identifier the pointer to the terms and conditions server,
providing to the user in response to presentation of the pointer, terms and conditions information,
enabling the user to indicate assent to the terms and conditions,
in response to the assent, permitting the user to access the digital object including performance of the object.

15. A method for maintaining a record of information concerning digital objects stored on a network, each of the digital objects comprising a set of digits and having an associated identifier which is unique across the network, the method comprising
storing the digital objects on the network in a manner that restricts unauthorized access to and transactions associated with the digital objects,
providing a reference service on the network, separate from the storage of the digital objects, for recording information about accesses to and transactions associated with the digital objects,
recording in the reference service information about accesses to and transactions associated with the digital objects, and
permitting access to the records of the reference service to authorized users.

16. A method for managing registration of claims to rights in digital objects and any works or other information or material that the object may be based on or incorporate, comprising
storing, in a repository which is accessible on a wide area network, copies of the digital objects, in a manner that enables only authorized accesses to the digital objects and permits verification that the stored digital objects have not been subjected to unauthorized alteration,
at an information and reference server which is accessible on the network at a different network address from the repository, providing registration services including receipt via the network of registration requests and delivery via the network of registration certifications, and
accessing, from the repository via the network, the objects for use in providing the registration services.

17. The method of claim 16 further comprising
enabling owners of rights in digital objects to deposit copies of the digital objects in the repository, via the network.

18. The method of claim 17 further comprising
providing a service, accessible on the network, for generating a unique handle for each digital object.

19. The method of claim 18 wherein
the handle for a digital object is unique both across the network and over time.

20. The method of claim 18 further comprising
providing a service, accessible on the network, for generating the handle and locating the pointer associated with the handle for a digital object.

21. The method of claim 18 wherein the handle is used to obtain a pointer to the network location of an accessible copy of the digital object.

22. The method of claim 18 wherein the handle comprises a pointer to the network location of information concerning obtaining authorization to use the digital object.

23. The method of claim 18 wherein the service is provided at multiple different locations on the network.

24. The method of claim 20 wherein the service is provided at multiple different locations on the network.

25. The method of claim 18 wherein the handles comprise character strings associated with the servers which generated them.

26. The method of claim 21 further comprising
providing a service, accessible on the network, for providing the pointer in response to a handle.

27. The method of claim 26 wherein there are multiple servers providing the service, each serving a portion of the handle space.

28. The method of claim 18 wherein there are multiple handle generation servers that may generate handles independently.

29. The method of claim 16 further comprising storing information concerning terms and conditions for access to and use of the digital objects.

30. The method of claim 29 wherein information concerning simple terms and conditions is stored in the repository.

31. The method of claim 16 wherein additional information concerning non-simple terms is held in a rights management system.

32. The method of claim 18 wherein each of the handles may be used to obtain one or more pointers to a location or locations on the network where a copy of the digital object-to which the handle is assigned is accessible.

33. The method of claim 32 wherein each of the handles may be used to obtain one or more pointers to one or more rights management system in which information concerning non-simple terms is held and where rights negotiation may be carried out.

34. The method of claim 18 wherein hash values are computed on the handles and the hash values are distributed among multiple handle servers, each handle server having a table which associates handles with pointers.

35. The method of claim 16 further comprising responding to requests, received via the network, for copies of the stored digital objects.

36. The method of claim 35 further comprising determining whether the requests for copies are authorized.

37. The method of claim 16 further comprising providing multiple repositories.

38. A method for providing a repository for use in network based regulation of claims in rights in digital objects comprising
storing copies of the digital objects in a repository accessible on the network, the copies being stored in a secure manner that precludes other than authorized access and that permits subsequent verification that there have been no unauthorized changes to the objects,
providing handles for the digital objects, each handle being unique across the network and over time, each handle including information sufficient to locate a copy of the digital object on the network, and
in connection with actions pertaining to regulation of claims in rights in the digital objects, using the handles to obtain authorized access to the digital objects.

39. The method of claim 38 wherein the actions include registration of claims in the rights.

40. The method of claim 39 wherein the actions include obtaining copies of the digital objects in exchange for compensation.

41. A network-based method for managing compensation for licensing of rights and other operations in digital objects, comprising
storing, in a recordation system available to authorized access on the network, information identifying the ownership of rights in digital objects,
receiving, at a rights management system available on the network, requests for rights in digital objects were the terms and conditions have not been stipulated in the properties record, and
in response to the requests for rights, issuing, from the rights management system to the recordation system via the network, requests to record information or transfers of rights in and other information pertaining to the digital objects and in works or other information or material on which the object may be based or incorporate.

42. The method of claim 41 wherein the rights comprise exclusive rights.

43. The method of claim 41 further comprising recording the transfer of rights in the recordation system in a manner which is secure against alteration.

44. The method of claim 41 wherein the request for transfer of rights is associated with a commitment to compensate the owner of the rights.

45. A method for compensating owners of rights in digital objects stored in a network for access to the digital objects by users via the network, comprising
storing on the network information associated with the digital objects and identifying the terms and conditions on which a user may have access to the digital objects via the network,
in connection with a request by a user for access to a digital object, fetching and providing to the user the terms and conditions, and
construing an action taken by the user in connection with requesting access to the digital object as agreement with the terms, and charging the user accordingly.

46. A method for managing handles for digital objects in a computer network comprising
including in the handle an indication of a local naming authority having control over generation of a subset of all global generated handles, and
including in the handle a string which is locally unique with respect to digital objects for which generation of handles are controlled by the local naming authority.

47. A method for managing generation of handles for digital objects in a computer network comprising
maintaining local naming authorities that control generation of handles for digital objects, the handles being a subset of all of the handles generated globally, and
maintaining a global naming mechanism that assures unique naming of the local naming authorities.

48. A method for managing handles for digital objects in a computer network comprising
managing some of the handles to be globally publicly accessible, and
managing some of the handles to be only locally and privately accessible.

49. A method of managing access to digital objects in repositories comprising
managing deposit of a digital object by accepting and storing the digital object and arranging for the generation and storage of an associated handle for the object, and
managing access to the digital object by a accepting and receiving a service request which-includes a handle.

50. A system of managing digital objects in a network comprising
a system of repositories which accept, store, and make disseminations of digital objects and portions of digital objects in response to requests received from any arbitrary location in the network,
a system of handle servers which provide services in connection with handles for digital objects stored in the repositories, and
a system of naming authorities which controls generation of handles on a global and local basis to assure locally unique and globally unique handles for digital objects.
